(19) United States
(12) Patent Application Publication
(10) Pub. No.: US 2025/0265850 A1
(43) Pub. Date: Aug. 21, 2025

(54) TECHNIQUES FOR AUTOMATICALLY MEASURING CELL DYNAMICS IN MICROSCOPIC VIDEO

(71) Applicant: The Regents of the University of California, Oakland, CA (US)

(72) Inventors: Abolfazl Zargari, Santa Cruz, CA (US); Ali Shariati, Santa Cruz, CA (US); Gerrald Lodewijk, Santa Cruz, CA (US); Najmeh Mashhahdi, Santa Cruz, CA (US)

(21) Appl. No.: 19/056,446

(22) Filed: Feb. 18, 2025

Related U.S. Application Data
(60) Provisional application No. 63/553,768, filed on Feb. 15, 2024.

(51) Int. Cl. G06V 20/69; G06T 7/00; G06T 7/12; G06T 7/13; G06T 7/20; G06T 7/62

(52) U.S. Cl. CPC G06V 20/695; G06T 7/0012; G06T 7/12; G06T 7/13; G06T 7/20; G06T 7/62; G06T 2207/10056; G06T 2207/30024

(57) ABSTRACT

Techniques for measuring cell dynamics include training a segmenting model with segmenting training data that indicates cell boundaries for each of one or more images. A tracking model is trained with linkages between a boundary of each cell in a first image and in a second image in the segmenting training data. Observations that indicate multiple images of a microscopic video are retrieved. Boundary data that indicates a boundary of each cell in at least two images of the observations is generated based on the observation data and the segmenting model. Tracking data that indicates a linkage between a boundary of a first cell in a first image and in a second image is generated based on the boundary data and the tracking model. Cell dynamics of the first cell are generated based on the boundary of the first cell in the first and second images and sent.

### CROSS REFERENCE TO RELATED APPLICATIONS

This application claims benefit of Provisional Appln. 63/553,763, filed Feb. 15, 2024, the entire contents of which are hereby incorporated by reference as if fully set forth herein, under 35 U.S.C. § 119(e).

### STATEMENT OF GOVERNMENTAL INTEREST

This invention was made with government support under Grants K99GM126027, R00GM126027, and R01HD098722 awarded by the National Institutes of Health. The government has certain rights in the invention.

### BACKGROUND

Cell dynamics includes the identification and tracking over time of features of a single biological cell derived from an organism, as observed in microscopic video. Video consists of image frames of spatially related scenes separated in time. Video includes time-lapse video in which the time steps between captured image frames is longer than during replay. Microscopic video is video with a magnified view sufficient to reveal cells of a biological organism. Many modalities of generating microscopic video of such biological cells are known. Traditional methods often struggle with the precise determination of cell dynamics, particularly in phase-contrast imaging modalities.

### SUMMARY

Techniques are provided for automatically measuring cell dynamics in microscopic video using machine deep learning by configuring neural networks suitable for image processing, such as convolutional neural networks trained with specialized training sets.

In a first set of embodiments, a method for measuring cell dynamics includes retrieving from a computer-readable medium observation data that indicates a plurality of image frames of a microscopic video suitable for detecting a biological cell. The method also includes generating boundary data that indicates a boundary of each cell in at least two image frames of the observation data based on the observation data and a segmenting neural network. The segmenting neural network is trained with segmenting training data that indicates cell boundaries for each of one or more frame images different from any frame images in the observation data. The method further includes generating tracking data that indicates a linkage between a boundary of a first cell in a first image frame of the at least two image frames and a boundary of the first cell in a second image frame of the at least two image frames based on the boundary data and a tracking neural network. The tracking neural network is trained with tracking training data that indicates linkages between a boundary of each cell in a first image frame and a boundary of a corresponding cell in a second image frame for each boundary in the segmenting training data. Still further, the method includes generating cell dynamics data for the first cell based on the boundary of the first cell in the first image frame and the boundary of the first cell in the second image frame. Even further still, the method includes sending a signal that indicates the cell dynamics data for the first cell.

In some embodiments of the first set, the segmenting training data includes one or more augmented frame images derived from a non-augmented frame image by randomly varying the location or size of one or more cells and the corresponding boundaries or by randomly changing one or more image properties such as intensity, contrast, noise, or clutter, or some combination.

In some embodiments of the first set, the segmenting training data includes a number of frames with edge-touching cells that is a same order of magnitude as a number of frames without edge touching cells.

In some embodiments of the first set, the segmenting neural network includes a residual convolutional layer.

In some embodiments of the first set, the segmenting neural network includes an edge detection layer configured to give more weight to nodes representing image pixels near a boundary of a cell.

In some embodiments of the first set, the segmenting neural network is progressively trained on increasingly higher resolution imagery.

In some embodiments of the first set, the tracking training data includes one or more augmented linkages derived from a non-augmented linkage by randomly varying the shape of one or more boundaries.

In some embodiments of the first set, the tracking training data includes a number of cell division linkages that is a same order of magnitude as a number of linkages without cell division.

In some embodiments of the first set, the tracking neural network includes a residual convolutional layer.

In some embodiments of the first set, the tracking neural network is progressively trained on increasingly higher resolution imagery.

In some embodiments of the first set, the cell dynamics data for the first cell includes cell size or nucleus size or growth rate or mitosis or cell life cycle or changes thereof for the first cell, or some combination.

In a second set of embodiments, a method executed on a processor for measuring cell dynamics includes training a segmenting neural network with segmenting training data that indicates cell boundaries for each of one or more frame images. The method also includes training a tracking neural network with tracking training data that indicates linkages between a boundary of each cell in a first image frame and a boundary of a corresponding cell in a second image frame for each boundary in the segmenting training data. The method then includes retrieving from a computer-readable medium observation data that indicates a plurality of image frames of a microscopic video suitable for detecting a biological cell. The observation data is different from the segmenting training data. The method further includes generating boundary data that indicates a boundary of each cell in at least two image frames of the observation data based on the observation data and the segmenting neural network. Even further, the method includes generating tracking data that indicates a linkage between a boundary of a first cell in a first image frame of the at least two image frames and a boundary of the first cell in a second image frame of the at least two image frames based on the boundary data and the tracking neural network. Yet further still, the method includes generating cell dynamics data for the first cell based on the boundary of the first cell in the first image frame and the boundary of the first cell in the second image frame. In addition, the method includes sending a signal that indicates the cell dynamics data for the first cell.

In other sets of embodiments, a non-transient computer-readable medium or an apparatus or a neural network is configured to perform one or more steps of the above methods.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1A is a block diagram that illustrates an example of a training set, according to an embodiment;

FIG. 1B is a block diagram that illustrates an example of a method for training a model by setting model parameters based on the training set, according to an embodiment;

FIG. 2A is a block diagram that illustrates an example of a neural network for illustration;

FIG. 2B is a plot that illustrates examples of activation functions used to combine inputs at any node of a feed forward neural network, according to various embodiments;

FIG. 3A through FIG. 3I are images that depict frames from a video microscope at various levels of processing for forming training sets for cell dynamics, according to an embodiment;

FIG. 3J is a graph that illustrates an example of labeling of cells in image frames that links cells and any daughter cells in one frame to the same or parent cells in the preceding frame for cell dynamics, according to an embodiment;

FIG. 4 is a block diagram that illustrates an example of system for training and using neural networks for measuring cell dynamics, according to various embodiments;

FIG. 5 is a flow chart that illustrates an example of a method to train a neural network for cell segmentation, according to an embodiment;

FIG. 6 is a flow chart that illustrates an example of a method to train a neural network for cell tracking from one video frame to the next, according to an embodiment;

FIG. 7 is a flow chart that illustrates an example of a method to use the trained segmenting and tracking neural networks to measure cell dynamics, according to an embodiment;

FIG. 8 is a block diagram that illustrates an example of neural network structure for segmenting cells in a microscopic video frame, according to an embodiment;

FIG. 9 is a block diagram that illustrates an example of neural network structure for tracking cells in a pair of sequential, labelled, segmented microscopic video frames, according to an embodiment;

FIG. 10 is a block diagram that illustrates an example of progressive training of a neural network structure used for cell dynamics, according to an embodiment;

FIG. 11 is a plot that illustrates another example of superior performance in both latency and precision by the cell dynamics system, according to an embodiment;

FIG. 12 and FIG. 13 are tables that illustrate examples of superior performance by the cell dynamics system, according to an embodiment;

FIG. 14 is a series of image frames that illustrate an example of successful tracking of cell mitosis by the cell dynamics system, according to an embodiment;

FIG. 15 is a table that illustrates an example of superior precision by the cell dynamics system, according to an embodiment; and

FIG. 16 is a block diagram that illustrates a computer system upon which an embodiment of the invention may be implemented;

### DETAILED DESCRIPTION

A method and apparatus are described for automatically measuring cell dynamics in microscopic video. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are described below in the context of phase contrast microscopic video of mouse or human tissue cells. However, the invention is not limited to this context. In other embodiments other microscopic video modalities, such as transmission, reflection, color, fluorescence, or electron microscopy, are used to observe other types of human or animal or plant or fungal cells in vivo, or in vitro or in other cytometry apparati, with or without measurement of other physical attributes of the cells, such as volume, mass, electrical conductivity, tagged fluorescence or radioactivity, dynamic cellular processes, cell division patterns, cell movement and migration, changes in cell shape, intracellular movement, cell-cell interactions, response to stimuli, phagocytosis or endocytosis activities, or other property indicative of cell type.

### 1. Overview of Machine Learning

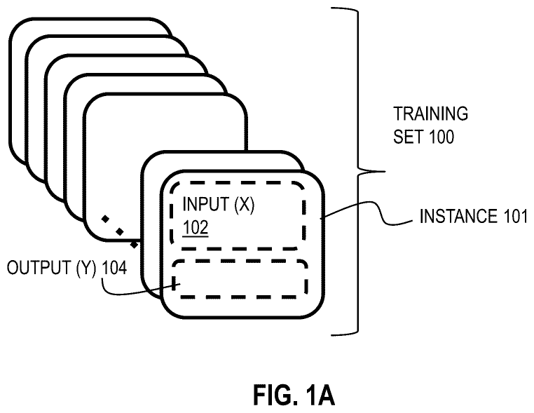

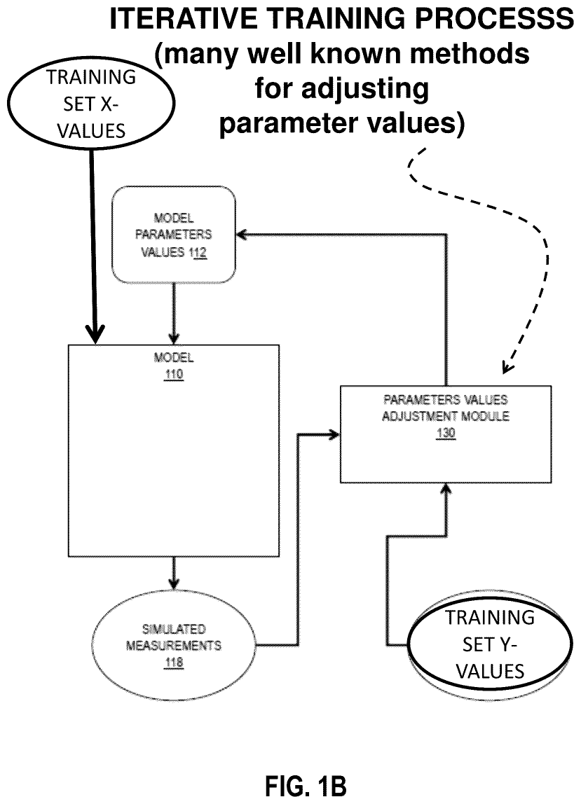

FIG. 1A is a block diagram that illustrates an example of a training set 110, according to an embodiment. The training set 100 includes multiple instances, such as instance 101. The instances 101 for the set 100 are selected to be appropriate for a particular use. Each training set 100 instance 101 includes input data 102 (represented by the variable X, such as one or more input images) and output data 104 (represented by variable Y) desired to be output from the artificial intelligence machine (such as a classification or binary mask or vector of attributes or an output image) given the input data X 102.

In general, the artificial intelligence machine is programmed with a model M that includes a variety of adjustable parameters P, the values for which are determined by training with the training set 100 to provide a given output 104 for a given input 102 of each instance 101 of the training set 100. Many training methods are known and can be used alone or in combination to train the machine model based on the training set 100.

During machine learning, a model M is selected appropriately for the purpose and data at hand. One or more of the model M adjustable parameters P is uncertain for that particular purpose and the values for such one or more parameters are learned automatically. Innovation is often employed in determining which model to use and which of its parameters to fix and which to learn automatically. The learning process is typically iterative and begins with an initial value for each of the uncertain parameters P and adjusts those prior values based on some measure of goodness of fit of its Model output Y_{M} with known results Y for a given set of values for input context variables X from an instance 101 of the training set 100.

FIG. 1B is a block diagram that illustrates an example of an automatic process for learning values for uncertain parameters P 112 of a chosen model M 110. The model M 110 can be a Boolean model for a result Y of one or more binary values, each represented by a 0 or 1 (e.g., representing FALSE or TRUE respectively), a classification model for membership in two or more classes (either known classes or self-discovered classes using cluster analysis), other statistical models such as multivariate regression or neural networks, or a physical model, or some combination of two or more such models. A physical model differs from the other purely data-driven models because a physical model depends on mathematical expressions for known or hypothesized relationships among physical phenomena. When used with machine learning, the physical model includes one or more parameterized constants, such as propagation loss coefficients, that are not known or not known precisely enough for the given purpose.

During training depicted in FIG. 1B, the model 110 is operated with current values 112 of the parameters P, including one or more uncertain parameters of P (initially set arbitrarily or based on order of magnitude estimates) and values of the input variables X 102 from an instance 101 of the training set 100. The values 116 of the output Y_{M} from the model M, also called simulated measurements, are then compared to the values 124 of the known or desired result variables Y 104 from the corresponding instance 101 of the training set 100 in the parameters values adjustment module 130.

The parameters values adjustment module 130 implements one or more known or novel procedures, or some combination, for adjusting the values 112 of the one or more uncertain parameters of P based on the difference between the values of Y_{M} and the values of Y 104. The difference between Y_{M} and Y 104 can be evaluated using any known or novel method for characterizing a difference, including least squared error, maximum entropy, fit to a particular probability density function (pdf) for the errors, e.g., using a priori or a posterior probability. The model M 110 is then run again with the updated values 112 of the uncertain parameters of P and the values of the context variables X 102 from a different instance 101 of the training set 100. The updated values 116 of the output Y_{M} from the model M 110 are then compared to the values of the known result variables Y 102 from the corresponding instance 101 of the training set 100 in the next iteration of the parameter values adjustment module 130.

The process of FIG. 1B continues to iterate until some stop condition is satisfied. Many different stop conditions can be used. The model can be trained by cycling through all or a substantial portion of the training set. In some embodiments, a minority portion of the training set 200 is held back as a validation set. The validation set is not used during training, but rather is used after training to test how well the trained model works on instances that were not included in the training. The performance on the validation set instances, if truly randomly withheld from the instances used in training, is expected to provide an estimate of the performance of the learned model in producing Y_{M} when operating on target data X with results Y that are not already known. Typical stop conditions include one or more of a certain number of iterations, a certain number of cycles through the training portion of the training set, producing differences between Y_{M} and Y less than some target threshold, producing successive iterations with no substantial reduction in differences between Y_{M}, and errors in the validation set less than some target threshold, or no substantial differences in the parameter values P, among others.

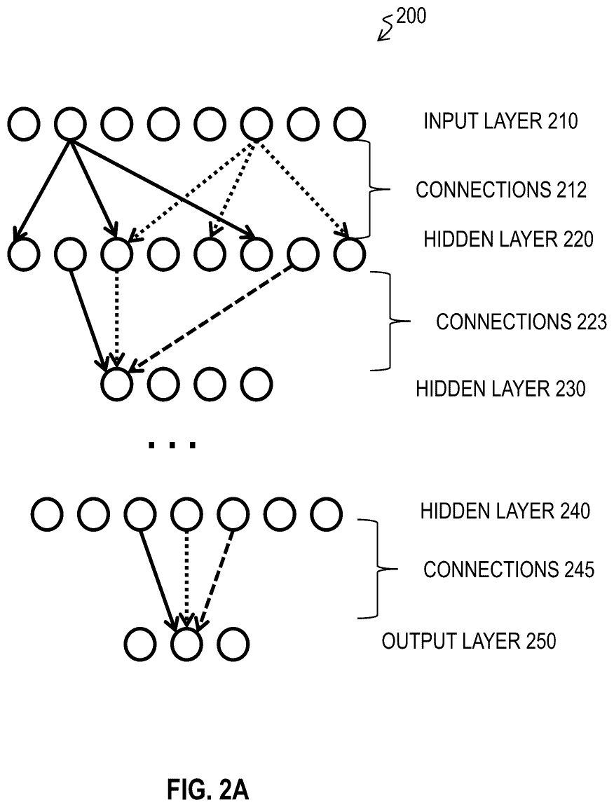

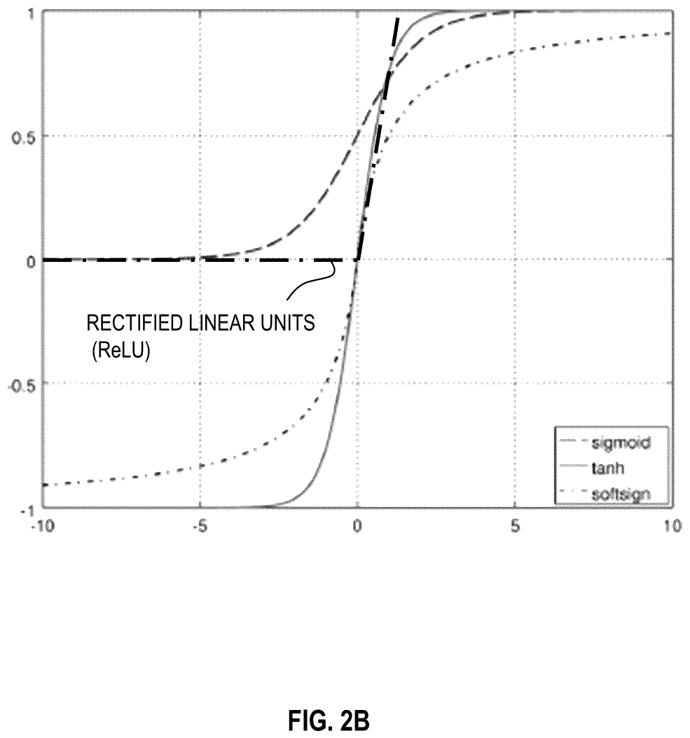

Effective training of an artificial intelligence system operating on imagery can be achieved using neural networks, widely used in image processing and natural language processing. FIG. 2A is a block diagram that illustrates an example neural network 200 for illustration. A neural network 200 is a computational system, implemented on a general-purpose computer, or field programmable gate array, or some application specific integrated circuit (ASIC), or some neural network development platform, or specific neural network hardware, or some combination. The neural network is made up of an input layer 210 of nodes, at least one hidden layer 220, 230 or 240 of nodes, and an output layer 250 of one or more nodes. Each node is an element, such as a register or memory location, that holds data that indicates a value. The value can be code, binary, integer, floating point or any other means of representing data. Values in nodes in each successive layer after the input layer in the direction toward the output layer is based on the values of one or more nodes in a previous layer. The nodes in one layer that contribute to the next layer are said to be connected to the node in the later layer. Connections 212, 223, 245 are depicted in FIG. 2A as arrows. The values of the connected nodes are combined at the node in the later layer using some activation function with scale and bias (also called weights) that can be different for each connection. Neural networks are so named because they are modeled after the way neuron cells are connected in biological systems, including the human vision system and brain. A fully connected neural network has every node at each layer connected to every node at any previous or later layer. Training a neural network is called deep learning.

FIG. 1B is a plot that illustrates examples of activation functions used to combine inputs at any node of a neural network. These activation functions are normalized to have a magnitude of 1 and a bias of zero; but when associated with any connection can have a variable magnitude given by a weight and centered on a different value given by a bias. The values in the output layer 250 depend on the values in the input layer and the activation functions used at each node and the weights and biases associated with each connection that terminates on that node. The sigmoid activation function (dashed trace) has the properties that values much less than the center value do not contribute to the combination (a so called switch off effect) and large values do not contribute more than the maximum value to the combination (a so called saturation effect), both properties frequently observed in natural neurons. The tanh activation function (solid trace) has similar properties but allows both positive and negative contributions. The softsign activation function (short dash-dot trace) is similar to the tanh function but has much more gradual switch and saturation responses. The rectified linear units (ReLU) activation function (long dash-dot trace) simply ignores negative contributions from nodes on the previous layer, but increases linearly with positive contributions from the nodes on the previous layer; thus, ReLU activation exhibits switching but does not exhibit saturation. In some embodiments, the activation function operates on individual connections before a subsequent operation, such as summation or multiplication; in other embodiments, the activation function operates on the sum or product of the values in the connected nodes. In other embodiments, other activation functions are used, such as kernel convolution.

An advantage of neural networks is that they can be trained to produce a desired output from a given input without knowledge of how the desired output is computed. There are various algorithms known in the art to train the neural network on example inputs with known outputs. Typically, the activation function for each node or layer of nodes is predetermined, and the training determines the weights and biases for each connection. A trained network that provides useful results, e.g., with demonstrated good performance for known results, is then used in operation on new input data not used to train or validate the network.

In some neural networks, the activation functions, weights and biases, are shared for an entire layer. This provides the networks with shift and rotation invariant responses. The hidden layers can also consist of convolutional layers, pooling layers, fully connected layers and normalization layers. The convolutional layer has parameters made up of a set of learnable filters (or kernels), which have a small receptive field. In a pooling layer, the activation functions perform a form of non-linear down-sampling, e.g., producing one node with a single value to represent four nodes in a previous layer. There are several non-linear functions to implement pooling among which max pooling is the most common. A normalization layer simply rescales the values in a layer to lie between a predetermined minimum value and maximum value, e.g., 0 and 1, respectively.

Attention is an artificial intelligence process that gives more weight to one object detected than another, e.g., giving more weight to specific pixels near edges in the input sequence than other pixels.

It has been found that neural networks of limited depth provide advantages in recognizing objects in image processing.

### 2. Machine Learning for Cell Dynamics

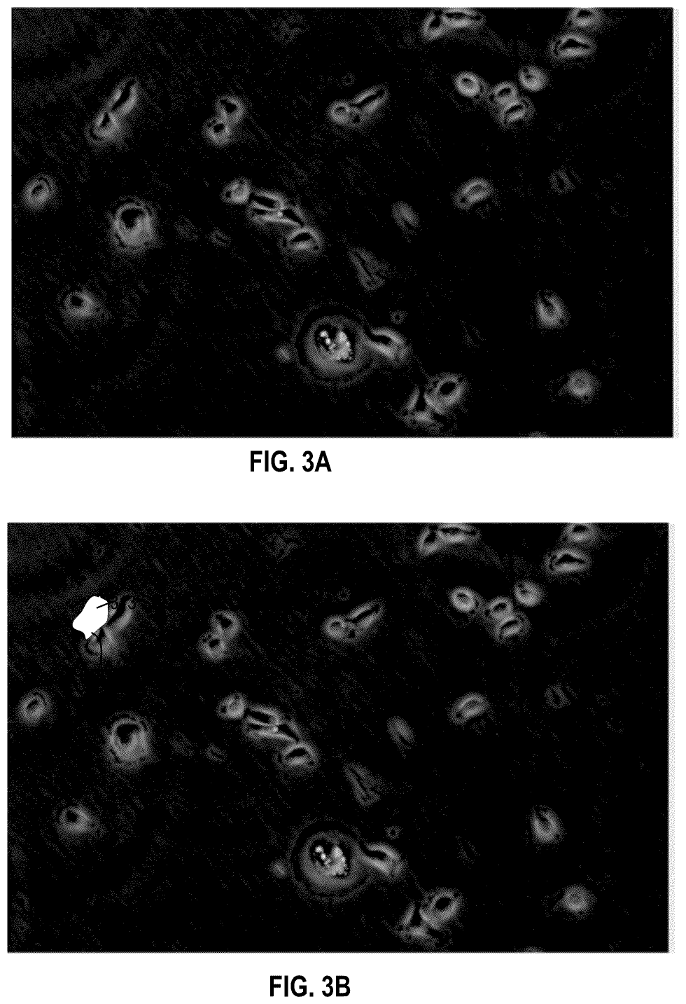

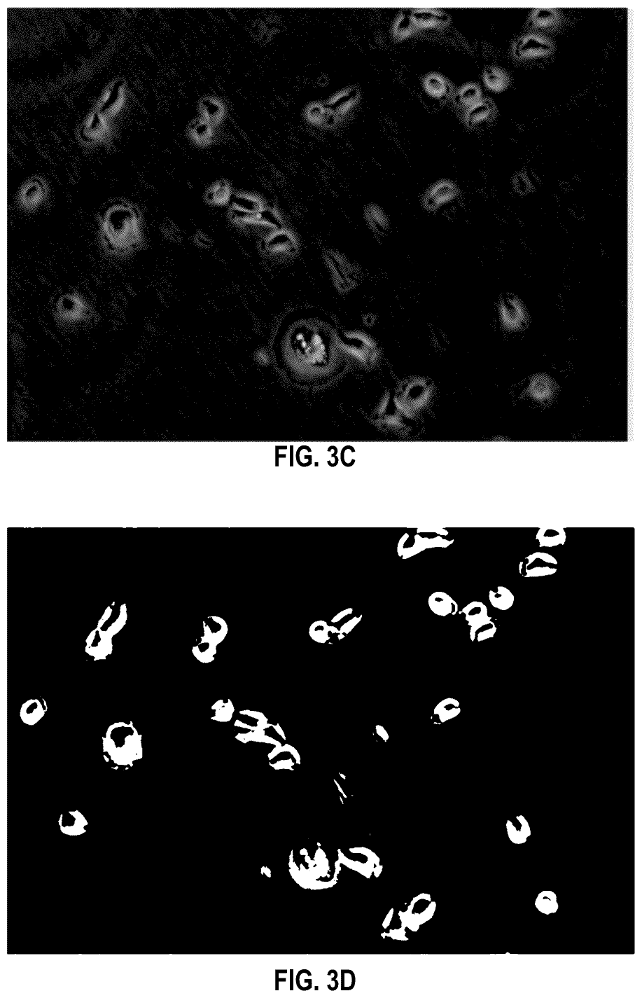

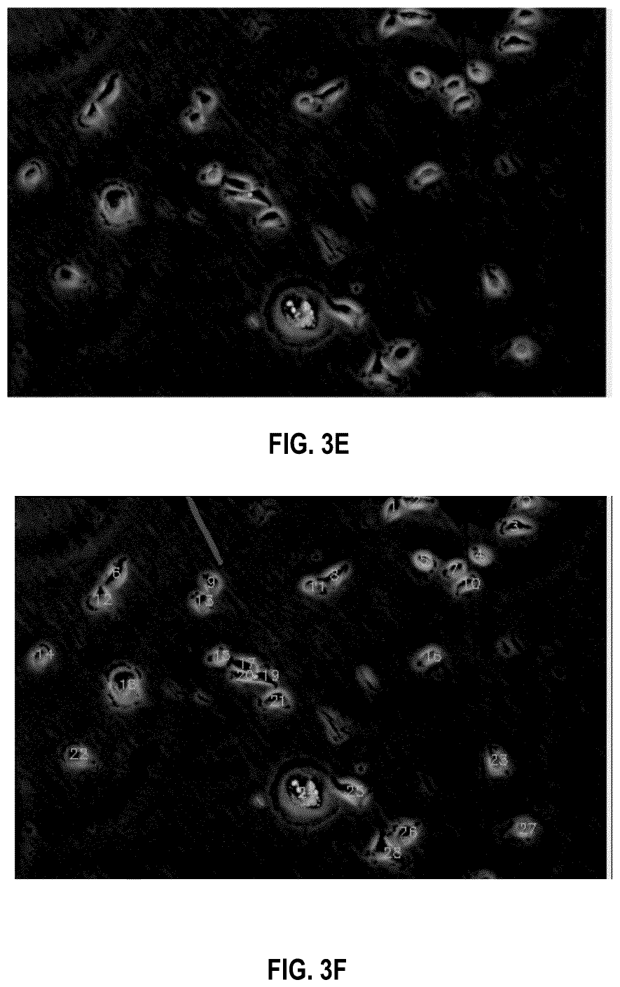

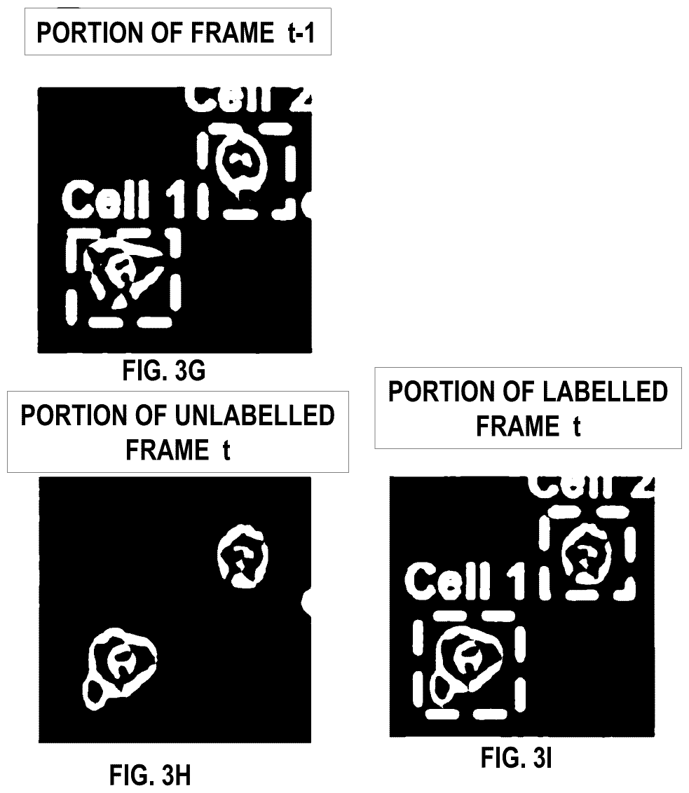

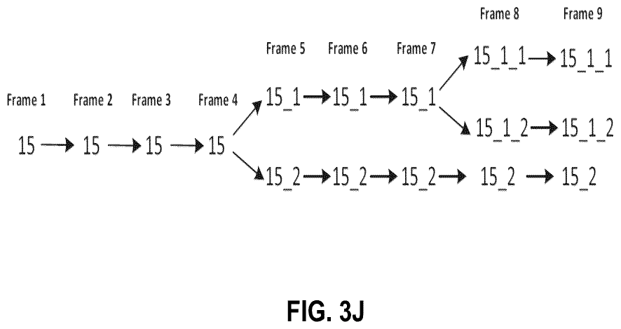

In the following, for simplicity, an image, or portion thereof, from one frame of microscopic video data that includes many frames is called a frame. FIG. 3A through FIG. 3I are images that depict frames from a video microscope at various levels of processing for forming training sets for cell dynamics, according to an embodiment. FIG. 3A depicts an example input frame 301 showing multiple cells, some isolated and some in contact with another cell. This frame, along with others, is stored in a data structure on a computer-readable medium, with pixel values indicating intensity for each pixel in an array of rows and columns of pixel locations. The data structure does not identify pixels associated with a cell or its nucleus versus pixels not associated with a cell or its nucleus.

In various embodiments, all the pixels associated with a cell or cell boundary are identified, e.g., in a data structure listing pixel row and column locations or in a image data structure called a mask in which each pixel location has one value (e.g. binary 1) for a cell or cell boundary and another value (e.g., binary 0) for not a cell or cell boundary. In some embodiments all the pixels associated with a nucleus of a cell or nucleus boundary are also identified, e.g., in a data structure listing pixel row and column locations or in a mask in which each pixel location has one value (e.g., binary 10) for a nucleus or nucleus boundary and another value (e.g., binary 00) for not a nucleus or nucleus boundary.

In some embodiments, each separate cell has its own list of pixels inside or on the boundary of the cell or cell nucleus, or its own mask. In some embodiments the mask consists of multiple values, one value (e.g., binary 0) for each pixel not inside a cell or nucleus or its boundary and a different value for each pixel inside a different cell or its nucleus or its boundary (e.g., binary 00010 for pixels inside a first cell and binary 00011 for pixels inside its nucleus, binary 00100 for pixels inside the next cell and binary 00101 for pixels inside its nucleus, etc.)

FIG. 3B depicts an example interim segmented frame 310a in which pixels associated with a single cell have been identified in a data structure. Pixels associated with this first cell outside its nucleus are indicated by highlighted pixels 312 of a segmented cell and pixels associated with the nucleus of the first cell are indicated by highlighted pixels 313 of a segmented nucleus. FIG. 3C reproduces input frame 301 from FIG. 3A and FIG. 3D depicts an example final segmented frame 310b in which pixels associated with every cell have been identified in a data structure, such as a mask of cells outside the corresponding nucleus.

FIG. 3E reproduces input frame 301 from FIG. 3A and FIG. 3F depicts an example labelled frame 320 in which a numbered cell label 322 is associated with the pixels associated with every cell such as in a mask of cells and corresponding nucleus. In the example embodiment, the labels are decimal numbers; but, in other embodiments any other labels may be used such binary numerals, letters or any combination of alphanumeric characters. Insoem embodiments, the labels refer to separate masks or mask values. The cell or nucleus labels are used to link cells identified in one frame to the same or daughter cells observed in subsequent frames (later in time)

There are a large variety of known automated and manual approaches to associate each pixel with a cell or its nucleus. These tend to consume large amounts of computational resources with one or more manual steps that cause the process to be time consuming and tedious for any human operator. Such a process is expected to be employed to produce a basic set of training instances for deep learning segmentation. As explained in more detail below, a full training set can be augmented from the basic set, for example by generating more instances produced by adding noise to the initial image and by changing size and or translating and or rotating pixels of cells in both the initial and segmented images. By training a neural network in a deep learning process, the type of segmentation that is resource- and time-consuming can be replaced by a much more rapid segmenting neural network, as described in more detail below. In some embodiments, the deep learning neural network also provides the labels, but in some embodiments, the labels are applied automatically (g., based on an algorithm) or manually, or in some combination, to the segmented frame.

In a separate process called tracking, a labeled segmented frame is used with the next, but unlabeled segmented frame, to label the segments in that next frame. This process is feasible provided the time between frames is small compared to the time that a cell is visible to the recording microscopic video device. The time a particular cell is visible can be determined in any way known in the art, such as by determining the velocity of fluid passing by the microscopic video recorder, the frame rate and the size of the field of view of the microscopic video recorder.

FIG. 3G shows a portion of frame number (t−1) collected before the next frame, frame number (t). This portion of frame (t−1) has been labeled for two cells, for convenience labeled Cell 1 and Cell 2, respectively. The label refers to a cell inside a dashed box adjacent to the label. FIG. 3H shows a corresponding portion of the next frame, frame number (t). This portion of frame (t) has not been labeled. This portion of frame (t) may be displaced from the position of the portion in frame (t−1) by a displacement vector given by the velocity of the fluid holding the cells multiplied by the time between the two frames. Deep learning is desirable to provide a neural network that will produce labels in frame (t), such as are shown in FIG. 3I, the corresponding portion of frame (t) with labels inherited from and corresponding to the labels in portion of frame (t−1). To train such a neural network, a training set of associated input X of labeled frame (t−1) and unlabeled frame (t) and desired output Y of labeled frame (t). The tracking training set can be built with a basic set of training instances produced manually or using high resource consuming algorithms or some combination and then augmenting the basic set of instances, for example by adding instances produced by adding noise or translation or rotation or adding or deleting or changing size of segmented cell masks, or some combination, to the basic instances.

The outputs Y from the tracking neural network, for both training purposes and operational uses, are a set of labelled frames with labels that propagate from frame to frame. FIG. 3J is a graph that illustrates an example of labeling of cells in image frames that links cells and any daughter cells in one frame to the same or parent cells in the preceding frame for cell dynamics, according to an embodiment. As depicted in this embodiment, labels are unique and numeric (e.g., 15). If a cell divides into two new daughter cells during the observation period, the new daughter cell labels start with the mother cell label followed by “_” (underline) and unique daughter cell labels. As illustrated in FIG. 3J, given the mother's cell label is “15” and cell division happens in frame (5), daughter cells are produced labelled 15_1 and 15_2. Another division for daughter 151 happens in frame (8) and produces daughters labelled 15_1_1 and 15_1_2.

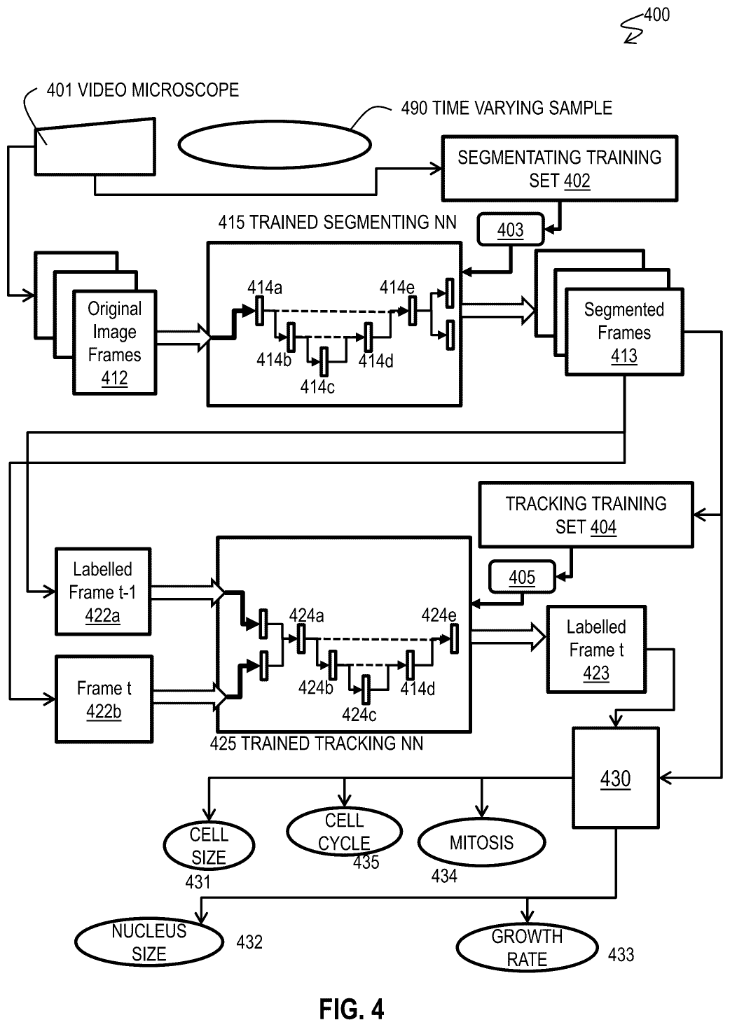

FIG. 4 is a block diagram that illustrates an example of a system 400 for training, and subsequently using, neural networks 415 and 425 for measuring cell dynamics, according to various embodiments. Although a time varying sample 490 is displayed for purposes of illustration, sample 490 is not part of system 400. A microscopic video device 401 collects microscopic images suitable to detect individual cells in a viewing area of sample 490 at multiple different times. Any device capable of taking microscopic images successively in time may be used, including optical transmission or confocal microscopes with a camera or charge-coupled device CCD or similar image capture device viewing a slide, a petri dish, a fluid channel or microfluidic channel, or a scanning electron microscope similarly situated. The output of microscopic video device 401 includes multiple time separated images (also called image frames or simply frames) of the sample viewing area. Collected together in time order, the image frames are called microscopic video data (or simply microscopic video). Microscopic video such as frame 301 collected for training in deep machine learning makes up the input values X of the segmenting training set 402 for segmenting neural network (NN) model.

Associated with each frame 301 in observation data destined for the input X of training set 402 is a segmentation image 310b, such as a binary mask, indicating the image pixels associated with a single cell for each of one or more cells in the image. During the training of neural networks, a separate standard way of segmenting the observation data is performed, e.g. using a highly computationally intensive rule-based system, or slow and tedious manual human input. In some embodiments, the human manual input is aided by a graphical user interface, e.g., implemented by the inventors in MATLAB™ by MATHWORKS™ of Natick Massachusetts, to display the image and allow a human user to outline and label individual cells or cell nuclei or both, and store the results as binary mask with a cell identifying label for each cell or nucleus or both. The collection of segmented images (such as frame 310b) make up the output Y of the training set 402. Each instance 101 of the training set 100 includes one frame (such as frame 301) of the microscopic video as instance input X 102 and the corresponding segmentation mask image of segmented images (such as frame 310b) as instance output Y 104.

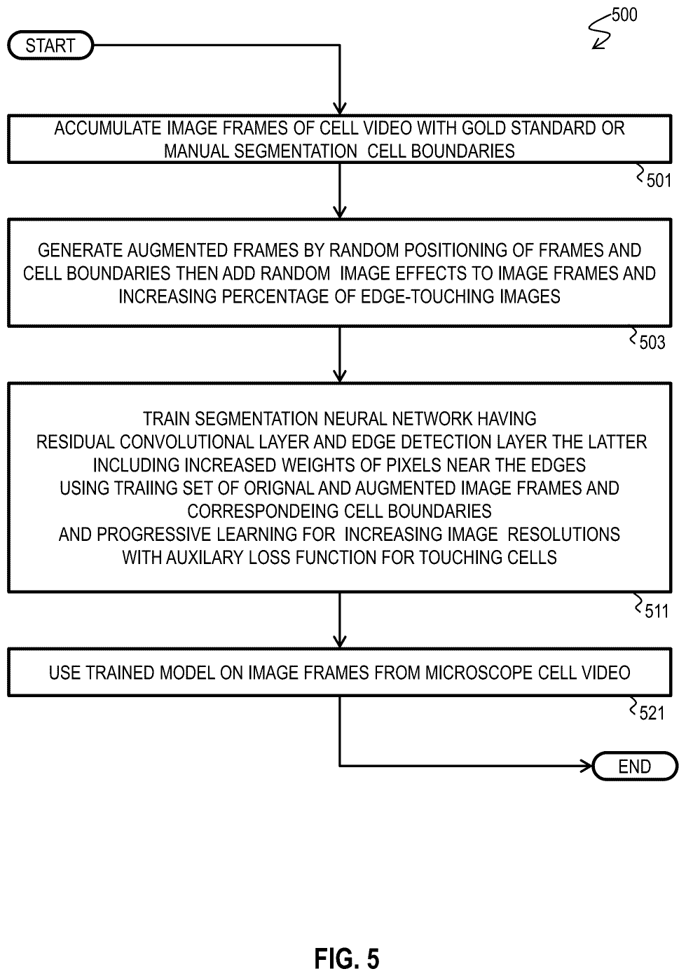

The input images (such as frame 310b) and corresponding segmentation images (such as frame 310b) are used in a deep learning process 403 to train a segmenting neural network 415. For example, segmenting neural network 415 includes layers 414a, 414b, 414c, 414d and 414e. In other embodiments, more or fewer layers are used, such as a number of layers ranging from 20 to 50. This range includes various types of layers, such as convolutional layers (approximately 10 to 20), pooling layers (around 2 to 5 for down-sampling), up-sampling layers (comparable in number to pooling layers for up-sampling and reconstructing the image), and residual layers (about 2 to 6, which help in training deeper networks effectively). Optional layers can also be included, such as edge detection layers (1 to 3, to enhance edge features), and attention mechanisms (1 to 3, to focus on relevant features for better segmentation). The architecture may also incorporate batch normalization layers after each convolutional layer and skip connections, particularly in U-Net inspired architectures, to combine features from different levels of the network corresponding to different size scales of features. The specific number and type of layers can be adjusted based on the complexity of the segmentation task and the computational resources available, ensuring a balance between model complexity and efficiency. This process is described in more detail below with respect to the flow chart in FIG. 5. Used by itself, the trained segmenting neural network 415 can take microscopic video input 412 and produce corresponding segmented image frames 413, which can be called segmented video.

The system 400 also includes linking the binary masks in the segmented image of one frame to corresponding binary masks in a segmented image of the next frame, where the linked correspondence (also called a linkage) indicates the same individual cell as imaged in the two successive frames. Such linkages indicate not just cell migration (translation and rotation) and cell shape changes from one frame to the next but also cell division from one parent cell to two daughter cells. The process of producing these linkages is called tracking herein. For training purposes, training segmented frames are processed by standard processing, e.g., computationally heavy rule-based or human manual linkage formation. In some embodiments, the human manual input is aided by a graphical user interface, e.g., implemented by the inventors in MATLAB™ by MATHWORKS™ of Natick Massachusetts, to display the labeled masks in the previous frame, frame (t−1), and allow a human user to link those labeled masks for frame (t−1) to the masks in the next frame, frame (t) thus inheriting the label, in whole or in part, from the previous frame.

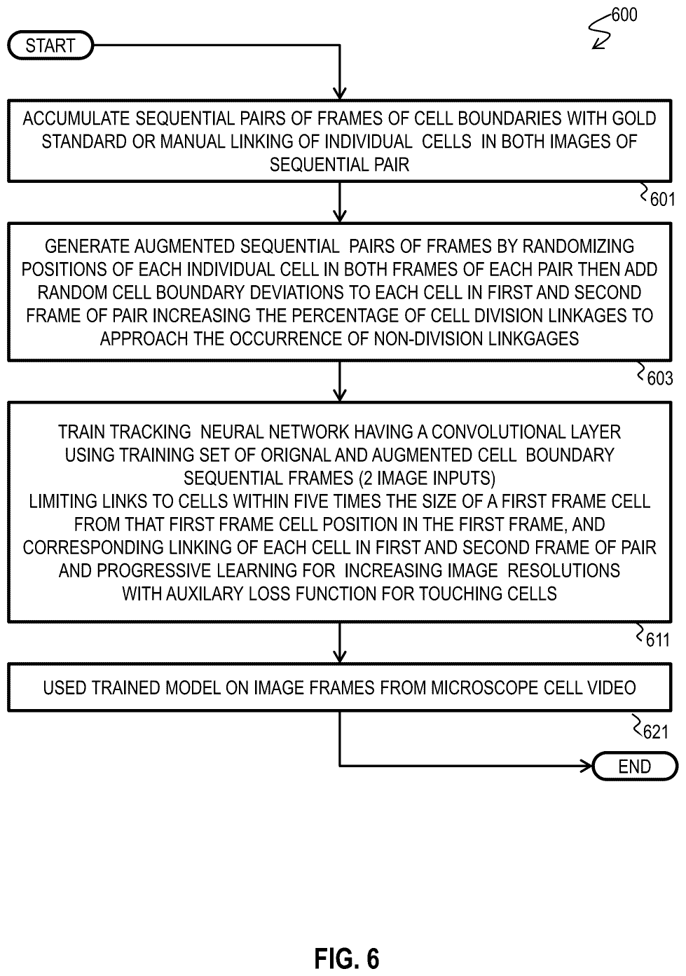

The two successive frames, frame (t−1) and frame (t), with the labels on the previous frame (t−1) constitute the input X 422 for deep learning process 405 using a tracking neural network 425. For example, tracking neural network 425 includes layers 424a, 425b, 424c, 424d and 424e. In other embodiments, more or fewer layers are used, such as a number of layers ranging from 20 to 50. This range includes various types of layers, such as convolutional layers (approximately 10 to 20), pooling layers (around 2 to 5 for down-sampling), up-sampling layers (comparable in number to pooling layers for up-sampling and reconstructing the image), and residual layers (about 2 to 6, which help in training deeper networks effectively). Optional layers can also be included, such as edge detection layers (1 to 3, to enhance edge features), and attention mechanisms (1 to 3, to focus on relevant features for better segmentation). The architecture may also incorporate batch normalization layers after each convolutional layer and skip connections, particularly in U-Net inspired architectures, to combine features from different levels of the network. The specific number and type of layers can be adjusted based on the complexity of the segmentation task and the computational resources available, ensuring a balance between model complexity and efficiency. This process 405 is described in more detail below with respect to the flow chart in FIG. 6. The output Y 423 is an image of the later frame (t) with inherited labels for any cell that appears in both, and with new labels for any new cell that appears. Each instance 101 of the tracking training set 100 includes two frames 422 of segmented images, one without labels at frame (t), such as frame 310b, and one with labels on the earlier frame (t−1), such as frame 320, as instance input X 102. A segmented image of the second frame (t) with inherited labels such as frame 320 serves as the output Y 104. In some embodiments, the tracking training set includes not only the segmenting training set but also additional segmentation images produced by the segmenting neural network on microscopic video not used to train the segmenting neural network.

The system 400 includes an analysis module 430 that takes the successive segmented and labeled images and determines time series for cell size 431 and nucleus size 432, each time based on single frame segmentation, and determines cell growth 433, mitosis events 434, and cell life cycle times 435 based on the successive frames with inherited labels produced by repeated application of the tracking neural network to provide linkages from one frame to the next to the next and so on. In other embodiments other cell dynamical properties ae determined, such as cell migration rates. Thus system 400 is configured to measure cell dynamics.

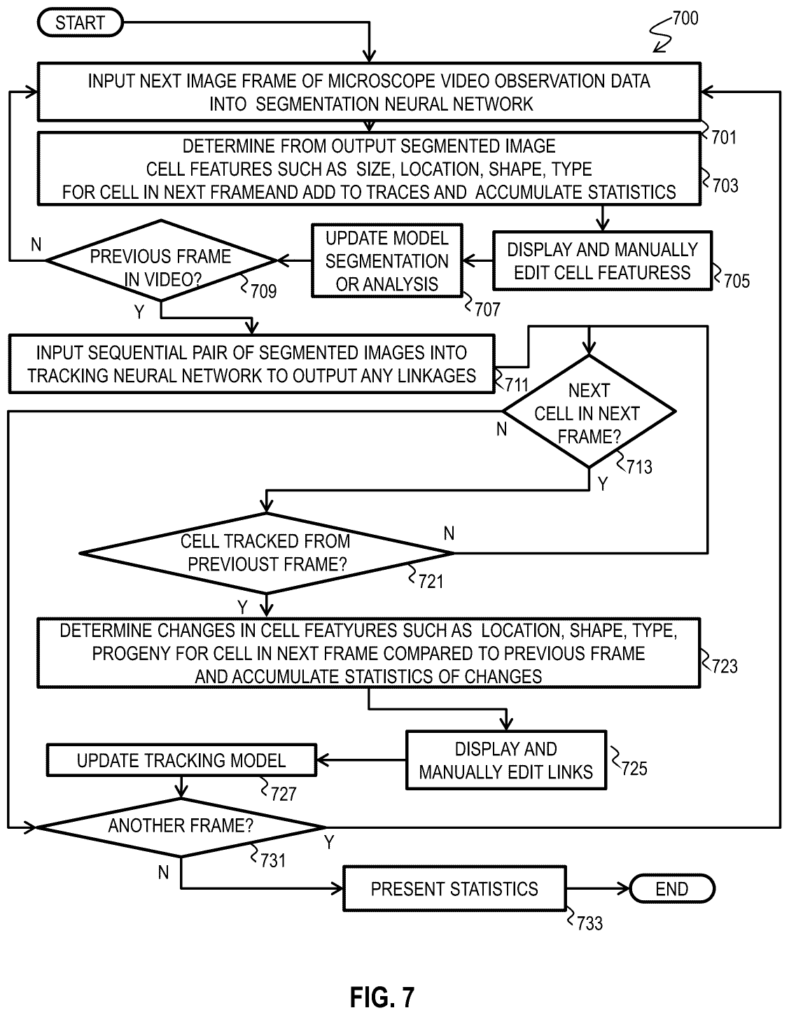

After the two neural networks 415 and 425 are trained and the analysis module 430 programmed, then they can be used together on operational observation data 412 made up of microscopic video not used in the training sets for either neural network. This use of the trained networks 415, 425 on new observational data 412 is described in more detail below with reference to FIG. 7. The linked binary masks 423 are then used to determine the cell dynamics of the observational data 412. Thus system 400 is configured to measure cell dynamics automatically for observational data 412, i.e., non-training set microscopic video.

FIG. 5 is a flow chart that illustrates an example method 500 to train a neural network 415 for cell segmentation, according to an embodiment. Method 500 is an embodiment of process 403 depicted above. Although steps are depicted in FIG. 5, and in subsequent flowcharts in FIG. 6 and FIG. 7, as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 501, image frames of cell microscopic video are collected or otherwise accumulated along with gold standard or manual segmentation of cell or cell nucleus boundaries or both, such as curves indicating pixels on the boundary or binary masks with constant values for all pixels inside the boundary for corresponding frames as basic training instances of segmenting training dataset 402. For example, highly computationally intensive segmentation algorithms are used, or manual input is received, to indicate pixels on and or inside each boundary. Producing such image frames and corresponding boundaries is a difficult task that limits the number of such instances for training a segmenting neural network.

In step 503, the number of instances for the segmenting training set 402 is augmented by reusing the instances collected in step 501 with randomly changed positions or rotations for both the image and the boundaries or randomly change intensity, or contrast, or noise, including in some embodiments, adding or removing random spots or multi-pixel particles in addition to any cells depicted, or some combination. This can augment the number of segmenting instances in the segmenting training set by several orders of magnitude. The extent of augmentation that is reasonable can vary depending on the original size of the dataset and the complexity of the segmentation task. Generally, augmentation factors can range from as low as 2 to 20 for datasets with high variability and large volume to as high as 100 to 100,000 for smaller or more uniform datasets where extensive augmentation is needed to introduce sufficient variability. In cases where the segmentation task is particularly challenging or the dataset is initially very limited, augmentation factors in the range of 10 to 1,000 might be most appropriate to ensure robust model training without overfitting. In order to ensure the trained segmenting neural network is sensitive to solid touching cells as well as free-floating cells, the number of instances of image frames with solid touching cells is artificially inflated as desired to provide the same order of magnitude of instance numbers as the number of frames instances with free floating cells.

In step 511, the segmenting neural network is trained using the augmented and non-augmented instances in segmenting training set 402 to accept an image frame of a microscopic video and output a segmented image frame with masks indicating the boundary or inside pixels associated with a single cell or cell nucleus. In some embodiments, the masks are binary indicating either inside or outside a cell. In some embodiments, each mask of pixels indicates a different cell so that each mask is associated with a label different from the label in a mask for a different cell or nucleus. In some embodiments, one mask indicates the boundary and inside of a nucleus for a cell and a second mask indicates the pixels outside the nucleus but on or inside the cell having that nucleus. In some embodiments the nucleus masks are in one output image and the output cell masks are in a separate output image. In some embodiments, multi-channel segmentation can be used, where each channel of the output image represents a different label, one for the cell and one for the nucleus. In some embodiments, each individual cell and nucleus is labeled with a unique identifier, allowing for distinct separation and identification of each cell and its nucleus within the image.

In some embodiments, the segmenting neural network includes a residual convolutional layer. In some embodiments, to speed training during step 511, one or more nodes of one or more layers of the segmenting neural network are first trained using low resolution imagery (such as images artificially and automatically subsampled, e.g., using pooling layers) and subsequent nodes or layers are trained using successively higher resolution images, in a process known as progressive training. For example, in segmenting neural network 415, layers 414a and 414b are pooling layers producing lower and lower resolution imagery, and layer 414c is trained on the lowest resolution imagery, layer 414d is trained on the next higher resolution imagery and layer 414e is trained on the highest resolution imagery. In some embodiments, to reduce the number of adjustable parameters, one or more or most neural network layers of the segmenting neural network are residual convolution layers. In some embodiments, a commercially available or open source version of a U-Net architecture is used that is built in with many of the above types of layer and varying resolutions.

In some embodiments, to enhance ability of the segmenting neural network to detect nucleus and cell edges, one or more nodes of one or more layers are configured as edge detection nodes or layers for which pixels are weighted more heavily for pixels closer to a boundary in the training set. To create each touching cell edge mask, we first created a weight map from the ground truth cell masks according to Equation 1.

$$w ( x ) = {w}_{0} {e}^{\frac{{( {d}_{1} ( x ) + {d}_{2} ( x ) )}^{2}}{2 {σ}^{2}}} \qquad ( 1 )$$

where x is pixels in the image, d₁ is the distance to the border of the nearest cell, d₂ is the distance to the border of the second nearest cell, and w₀ and σ were set to 10 and 25, respectively. Then a binary image is made by replacing all pixel values above a determined threshold (=1.0) with is and setting all other pixels to 0s.

In some embodiments, to enhance ability of the segmenting neural network to detect touching cell edges, the loss function used in parameter adjustment module 130 includes an auxiliary loss function for touching cells. The auxiliary edge representations (highlighting the edge area between touching cells) and the auxiliary training loss value (Equation 2) also encouraged the learning algorithm to spend more computational budget and time to separate the touching cells. They thus improved the model performance, especially for hard samples where we have high-density touching cells. This loss function is a linear combination of cross-entropy (CE) loss and Dice loss (DL) functions, as well as auxiliary loss functions (EdgeCE and EdgeDL) for the touching cell edge representations. CE takes care of pixel-wise prediction accuracy, while DL helps the learning algorithm increase the overlap between true area and predicted area, which is essentially needed where the number of image back-ground pixels is much higher than foreground pixels (object area pixels)

$$Loss = CE + DL + EdgeCE + EdgeDL \qquad ( 2 )$$

In step 521, the trained segmenting neural network 415 is used on observation data 412 as depicted in the method of FIG. 7, described in more detail below. Observation data 412 is microscopic video not used during training of the segmenting neural network or the training of the tracking neural network described below with reference to FIG. 6.

FIG. 6 is a flow chart that illustrates an example method 600 to train a neural network for cell label tracking from one video frame to the next, according to an embodiment. Method 600 is an embodiment of process 405 depicted above. In step 601, pairs of successive segmented image frames {frame (t−1) and frame (t)} from the segmenting output training set are collected or otherwise accumulated along with gold standard or manual linkages between masks in the earlier frame (t−1) to masks in the subsequent frame (t) to constitute a set of basic instances for tracking training set 404. For example, highly computationally intensive tracking algorithms are used, or manual input is received, to indicate masks in the later frame (t) that represent the same cell or progeny of the same cell and thus inherit a label of same cell from the earlier frame (t−1). Both augmented and non-augmented instances of the segmenting training set may be used. In some embodiments, additional microscopic video not used in training the segmenting neural network is passed through the segmenting neural network to produce additional pairs of segmented image frames. In any case, producing such image frames and linkages is a difficult task that limits the number of such instances for training a tracking neural network. Any label that indicates the evolution or division of a cell may be used, such as a name that concatenates the label in a frame when a cell first appears with a frame number and a daughter ID of any cells produced by mitosis of the parent.

In step 603, the number of instances for the tracking training set 404 is augmented by reusing the instances collected in step 601 with randomly changed positions or rotations for both the mask in the earlier frame (t−1) and the linked mask in the later frame (t), or randomly change intensity, or contrast, or noise, including in some embodiments, adding or removing random spots or multi-pixel particles in addition to any cells depicted, or some combination. This can augment the number of tracking training set instances in the augmented tracking training set by several orders of magnitude. The extent of augmentation that is reasonable can vary depending on the original size of the dataset and the complexity of the segmenting task. Generally, augmentation factors can range from as low as 2 to 20 for datasets with high variability and large volume to as high as 100 to 100,000 for smaller or more uniform datasets where extensive augmentation is needed to introduce sufficient variability. In cases where the tracking task is particularly challenging or the dataset is initially very limited, augmentation factors in the range of 10 to 1,000 might be most appropriate to ensure robust model training without overfitting. In order to ensure the trained tracking neural network is sensitive to dividing cells as well as non-dividing cells, the number of instances of image frames with dividing cells is artificially inflated as desired to provide the same order of magnitude of instance numbers as the number of frames instances with non-dividing cells.

In step 611, the tracking neural network 425 is trained using the augmented and non-augmented instances of the tracking training set to accept a pair of successive segmented image frames and output a re-labeled segmented image of the later frame (t) with segmentation labels indicating the same or progeny cell linkage with a labeled cell in the earlier frame (t−1). Step 611 is an embodiment of process 405 depicted above.

In some embodiments, to speed training during step 611, one or more nodes of one or more layers of the tracking neural network are first trained using low resolution imagery (such as images artificially and automatically subsampled, e.g., using pooling layers) and subsequent nodes or layers are trained using successively higher resolution images, in a process known as progressive training. For example, in tracking neural network 425, layers 424a and 424b are pooling layers producing lower and lower resolution imagery, and layer 424c is trained on the lowest resolution imagery, layer 424d is trained on the next higher resolution imagery and layer 424e is trained on the highest resolution imagery. In some embodiments, to reduce the number of adjustable parameters, one or more or most neural network layers of the training neural network are residual convolution layers. In some embodiments, a commercially available or open source version of a U-Net architecture is used that is built in with many of the above types of layer and varying resolutions or simultaneous training.

In step 621, the trained tracking neural network 425 is used on observation data as depicted in the method of FIG. 7, described in more detail below. Observation data is labelled and segmented microscopic video 422a and unlabeled segmented video frames 422b not used during the training of the segmenting neural network or the training of the tracking neural network.

FIG. 7 is a flow chart that illustrates an example method 700 to use the trained segmenting and tracking neural networks 415, 425 to measure cell dynamics, according to an embodiment. In step 701, the next image frame of microscopic video 412, for observation data not used to train either the segmenting neural network or the tracking neural network, is retrieved from a collection device 401 or local or remote storage or via a network message packet from a remote collection device or any other method for retrieving microscopic video data. Thus, step 701 includes retrieving from a computer-readable medium observation data that indicates a plurality of image frames of a microscopic video suitable for detecting a biological cell. Also in step 701, this retrieved image frame is input into the previously trained segmenting neural network 415, such as the segmenting neural network trained using method 500 in FIG. 5. Thus, step 701 includes using the segmenting neural network as indicated by step 521 of method 500. The output of the segmenting neural network is a segmented image showing cell boundaries (using boundary pixels or pixel masks) called herein boundary data. Thus step 701 includes generating boundary data for the next image frame 412 using the segmenting neural network trained as described in method 500.

In step 703, the boundary data indicating the boundaries of any cells in the image frame are used to determine one or more metrics of the cell suitable for determining cell dynamics. Such metrics include any one or any combination or all of nucleus size, cell size, nucleus shape, cell shape, and cell type as might be deduced by cell size, image intensity, or intensity variations, or color, or color variations within the mask for the cell, or relative size or orientation of cell and nucleus masks, or ancillary measurements, such as electronic impedance. Data indicating the values of one or more metrics and the associated frame number of time associated with the frame number are stored to accumulate the next point for a trace of cell changes (dynamics) and for accumulating cell statistics.

In step 705, omitted in some embodiments but shown here for other embodiments, the original image or the segmented boundaries, or both, are displayed for a user to review for quality assurance. In some of these embodiments, step 705 includes allowing a user to manually edit the segmentation boundaries or the cell metrics or some combination, e.g., using a graphical user interface. In step 707, one or more models, such as the segmenting neural network 415 or analysis module 430, is updated based on any changes made by the user during step 705. For example, a new segmenting training instance is added to the segmenting training set with the original image frame retrieved instep 701 and the user edited boundary for immediately or eventually retraining the segmenting neural network with or without generating further augmented versions of the retrieved image and user-edited boundaries. In some embodiments, step 707 includes updating the analysis module 430 to produce cell metrics from the original or edited boundary data which better matches any user-edited cell metrics. In some embodiments, step 707 includes updating both the segmenting neural network 415 and the analysis module 430. In some embodiments, steps 705 and 707 are omitted.

In step 709 it is determined whether there is a previous retrieved image frame from the observational data microscopic video already segmented. If not, control passes back to step 701 to retrieve the next frame. If there is already a previously retrieved and segmented image frame from the observational data, then control passes to step 711.

In step 711, the boundary data indicated in two sequential segmented image frames output from the segmenting neural network are input into the previously trained tracking neural network 425, such as the tracking neural network trained using method 600 in FIG. 6. Labels for the earlier frame are included as input, but the later frame is not labeled. Thus, step 711 includes using the tracking neural network as indicated by step 621 of method 600. The output of the tracking neural network is a set of linkages between cell boundaries (using boundary pixels or pixel masks) in previous image frame (t−1) and cell boundaries in the successive image frame (t). Thus step 711 includes generating tracking data that indicates a linkage between a boundary of a first cell in a first image frame of the observation data and a boundary of the first cell in a second image frame of the observation data based on the boundary data and a tracking neural network trained as described in method 600.

Steps 713 through 727 form a loop through each cell boundary in the successive frame (t). In step 713 it is determined if there is another cell in the successive frame (t). If not, control passes to step 731 described below. If there is another cell boundary in the successive frame (t), then control passes to step 721.

In step 721, it is determined if the next cell boundary is linked to a cell boundary in the previous image frame (t−1). If not, control passes back to step 713 to check for the next cell boundary, if any, in the current successive frame (t), as described above. In some embodiments, step 721 includes adding a new unique label for a cell not tracked to the previous frame before returning to step 713. If the next cell boundary is linked to a cell boundary in the previous image frame (t−1) then control passes to step 723.

In step 723, the changes in the linked cell boundaries are used to determine one or more metrics of the cell suitable for determining cell dynamics. Such metrics include any one or any combination or all of changes in nucleus size, changes in cell size, changes in nucleus shape, changes in cell shape, changes in cell location, changes in cell orientation, changes in cell type, mitosis, cell death among others of interest. Data indicating the values of one or more metrics and the associated frame number or time associated with the frame number are stored to accumulate the next point for a trace of cell changes (dynamics) and for accumulating cell change statistics. Thus step 723 includes generating cell dynamics data for the first cell based on the boundary of the first cell in the first image frame and the boundary of the first cell in the second image frame.

In step 725, omitted in some embodiments but shown here for other embodiments, the two segmented images and the linkages and changes in cell metrics are displayed for a user to review for quality assurance. In some of these embodiments, step 725 includes allowing a user to manually edit the linkages or changes in cell metrics, e.g., using a graphical user interface. In step 727, one or more models, such as the tracking neural network 425 or analysis module 430, are updated based on any changes made by the user during step 725. For example, a new tracking training instance is added to the tracking training set with the pair of segmented images and any user edited linkages for immediately or eventually retraining the training neural network with or without generating further augmented versions of the segmented images and user-edited linkages. In some embodiments, step 727 includes updating the analysis module 430 to produce cell metrics changes (i.e., cell dynamics) from the original or edited linkages which better match any user-edited cell dynamics, such as cell rotation, mitosis or death. In some embodiments, step 727 includes updating both the training neural network 425 and the analysis module 430. In some embodiments, steps 725 and 727 are omitted.

In step 731, reached after all cell boundaries in the current successive frame (t) have been processed, it is determined whether there is another frame in the microscopic video 412 of the observation data. If so, control passes back to step 701 to process the next frame in the microscopic video of the observation data. If not, control passes to step 733.

In step 733, the method computes, summarizes, sends or presents, or performs some combination on the traces or statistics of cell evolution measured in the microscopic video 412 of the observation data. Thus step 733 includes sending a signal that indicates the cell dynamics data for the first cell. In some embodiments, step 733 includes operating some device or administering some therapy based on the cell dynamics summarized, sent or presented. Then the process ends.

### 3. Example Embodiments

Three example embodiment using phase contrast microscopic video for mouse and human tissue are described here. These embodiments demonstrate both more efficient machine learning with fewer adjustable parameters P, and better performance than previous work in measuring cell dynamics.

An annotated dataset was created of phase-contrast live image sequences of three cell types: (1) mouse embryonic stem cells, (2) bronchial epithelial cells, and (3) mouse C2C12 muscle progenitor cells. To facilitate manual annotation of the cells, a MATLAB-based software was developed to generate a labeled training dataset, including pairs of original cell images and corresponding cell ground-truth mask images. To further generalize, image augmentation techniques were used to increase the size of the dataset with more variations efficiently and less expensively. In addition to six conventional image augmentation techniques with random settings such as cropping, changing the contrast and brightness, blurring, applying the vertical/horizontal flip, and adding Gaussian noise, a random cell movement method was developed and applied as a novel image augmentation strategy to generate new cell images (with their annotated masks) that look more different than the original existing samples. Next, the annotated and augmented dataset of cell images were used to train a supervised deep learning (DL)-based segmentation model called DeepSea to detect and segment the cell bodies.

### 3.3 Deapsea Training and Test Data

Mouse ESCs (V6.5) were maintained on 0.1% gelatin-coated cell culture dishes in 2i media (Millipore Sigma, SF016-100) supplemented with 100 U/ml Penicillin-Streptomycin (Thermo Fisher, 15140122). Cells were passaged every 3-4 days using Accutase (Inno-vate Cell Technologies, AT104) and seeded at a density of 5,000-10,000 cells/cm2. For live imaging, between 5000 and 10,000 cells were seeded on 35 mm dishes with a laminin-coated (Biolamina) 14 mm glass microwell (MatTek, P35G-1.5-14-C). Cells were imaged in a chamber at 37 C perfused with 5% CO2, a Zeiss AxioVert 200M microscope with an automated stage, and an EC Plan-Neofluar 5×/0.16NA Phlobjective or an A-plan 103/0.25NA Phl objective. The same culture condition was used for confocal imaging, except that 24 h after seeding, the media was replaced with 2 mL DMEM-F12 (Thermo Fisher, 11039047) containing 2 ul CellTracker Green CMFDA dye (Thermo Fisher, C2925) and placed back in the incubator for 35 min. Next, 2 ml of CellMask Orange plasma membrane stain (Thermo Fisher, C10045) was added, and the dish was incubated for another 10 min. Dishes were washed three times with DMEM-F12, after which 2 mL of fresh 2i media was added. Cells were imaged directly after the live-cell staining protocol using the Zeiss 880 Microscope using a 20×/0.4 N.A. objective and a 1 mm interval through the z axis.

Immortalized human bronchial epithelial (HBEC3kt) cell line homozygous for wildtype U2AF1 at the endogenous locus was obtained as a gift from the laboratory of Harold Varmus (Cancer Biology Section, Cancer Genetics Branch, National Human Genome Research Institute, Bethesda, United States of America and Department of Medicine, Meyer Cancer Center, Weill Cornell Medicine, New York, United States of America) and cultured according to Fei et al. This host cell line was used for lentiviral transduction and blasticidin selection to generate a line with stable expression of KRASG12V using a lentiviral plasmid obtained as a gift from the laboratory of John D Minna (Hamon Center for Therapeutic Oncology Research, The University of Texas Southwestern Medical Center) described in.37 Cells from passage 11 were grown to 80% confluency in Keratinocyte SFM (1×) (Thermo Fisher Scientific, USA) before being re-seeded as biological duplicates at three densities: 0.3M, 0.2M, and 0.5M cells per well in 6-well plates and allowed to adhere before live-cell imaging over a 48 h time period.

We collected phase-contrast time-lapse microscopy image sequences of three different cell types, including two in-house data-sets of Mouse Embryonic Stem Cells (MESC, 31 sets, 1074 images) and Bronchial epithelial cells (7 sets, 2010 images) and one dataset of Mouse C2C12 Muscle Progenitor Cells (7 sets, 540 images) obtained from an external resource with the cell culture described in.38 Our collected datasets are publicly available.

We designed an annotation software in MATLAB to manually create the ground-truth mask images corresponding to our cell images. We applied an image augmentation scheme to generate a larger dataset with more variations efficiently and less expensively, aiming to train a more generalized model. In our image augmentation scheme, in addition to conventional image transformations, we proposed moving the stem cell bodies by the random vectors of (q,d) relative to their center points, where q is the direction angle between 0 and 360 and d is the displacement in pixels. The proposed cell image augmentation method improved the model performance with unseen test images (different microscopy live imaging sets not used in the training set), confirming that it could less overfit training samples and thus help the model generalization. For each training image, we applied a pipeline of augmentation functions which were randomly selected and set.

As mentioned before, our dataset samples are label-free microscopy images that are usually noisy, low contrast, hard, and high cell density samples. It is difficult for any existing instance tools (that have not seen these types of images in their training process) to segment the cell bodies of our test images. The original pre-trained version of StraDist and StarDist models achieved an average precision of around 43% and 5%, respectively, on our test sets. We also compared the CellPose and StarDist outputs compared with the ground truth mask images.

### 3.2 DeapSea Neural Networks Structure and Training

The design of the DeepSea embodiment of the segmenting model is inspired by the UNET model, which has been successful in different segmentation tasks. Several innovative changes were made to make this model more suitable for single-cell live microscopy. First, 2D UNET was scaled down to considerably reduce the number of parameters and thus have a faster model that processes large high-resolution images with less computational and memory costs. To do this, the DeepSea model was modified with convolutional residual connections to increase the depth of the network with fewer extra parameters. By reducing the model size, we could feed larger high-resolution images into the model and get more accurate results39,40 with less computational and memory costs. However, to compensate for the model compression and also avoid the model from underfitting the training data, we modified the scaled-down 2D-UNET model with the convolutional residual connections. It has been proved that the residual connections can increase the depth of the network with fewer extra parameters. They also can accelerate the speed of the training of the deep network, reduce the effect of the vanishing Gradient Problem, and potentially obtain higher accuracy in network performance. Our DeepSea segmentation model involves only 1.9 million parameters, which is considerably smaller than typical instance segmentation models such as UNET, PSPNET, and SEGNET.

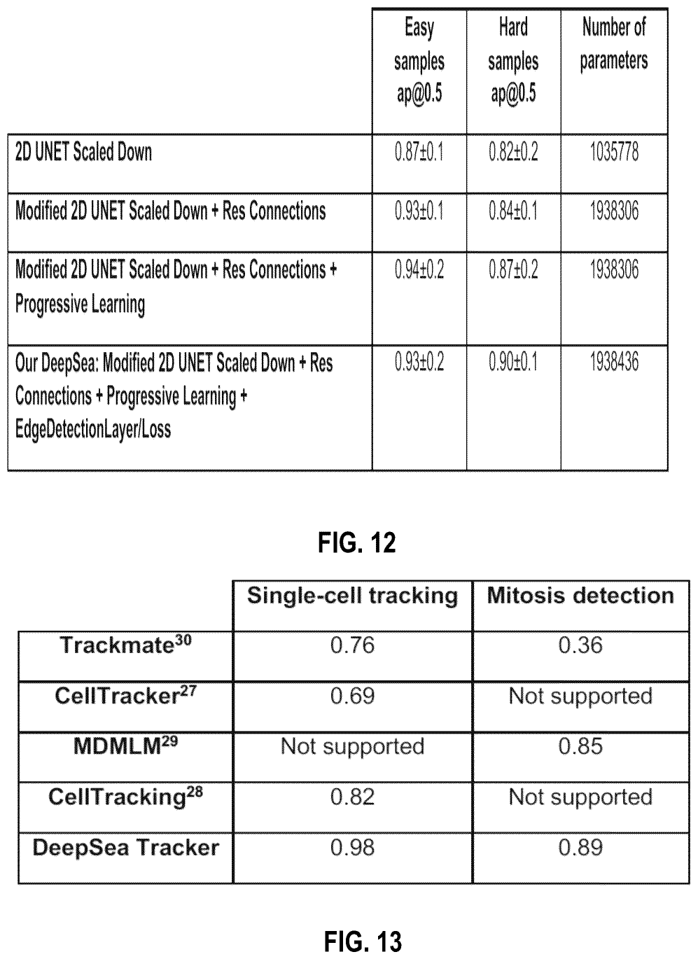

Second, an auxiliary edge detection layer trained on the edge area between touched cells was added to enhance the learning algorithm to focus on touching cell edges and thus improve the segmentation accuracy in hard samples with high-density touched cell images. In the training process, a progressive learning technique (used in progressive general adversarial networks [GANs]) was also used to help the model generalize well for different image resolutions and generate large high-resolution masks that better separate the touching cell edges. The progressive learning technique makes the model first learn coarse-scale features and then finer scale information. Table in FIG. 12, discussed in more detail below, shows how these proposed techniques and modifications can improve the segmentation scores for simple and crowded samples as measured by precision.

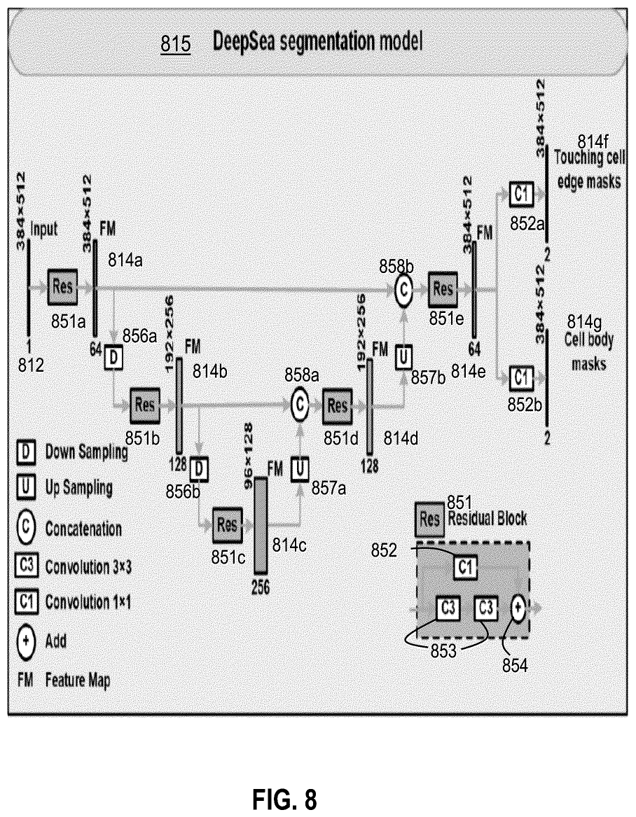

FIG. 8 is a block diagram that illustrates an example of neural network structure 815 for segmenting cells in a microscopic video frame, according to an embodiment. The DeepSea segmentation model 815 receives the label-free microscopy cell image 812 and returns two outputs of the touching cell edge mask 814f and the segmented cell body mask 814g. This model architecture applies 1) a scaled-down version of 2D-UNET, 2) residual blocks 851 to increase the depth of the model with fewer parameters, and 3) the auxiliary touching cell edge representations 814f to improve the performance of the model, especially in high-density cell cultures. In the illustrated embodiment, the input layer is an input frame 812 (an embodiment of frame 301) with 384 rows and 512 columns of pixel values passed through a residual block 851a to produce 64 channels of fine-scale feature map (FM) 814a, each channel of the same size (384×512) and representing the spatial features in the input image. Residual blocks 851 help to mitigate the “vanishing gradient” problem in deep neural networks by enabling information to propagate through multiple layers more effectively, which is particularly important when stacking many layers together. A portion of the input signal to a residual block 851 is directly passed through a “shortcut connection” 1×1 convolution layer C1 852 to the later layers. The remaining input is fed through a series of convolutional layers, such as 3×3 convolution layers C3 853 performing feature extraction. The output of these convolutional layers is then added inlayer 854 to the shortcut connection, creating the final output of the residual block 851. In the example embodiment, the pass through pixels go through a 1×1 convolution layer (C1) 852 and the processed pixels go through two successive 3×3 convolution layers (C3) 853.

In the next layers, the 64 channels of fine-scale feature map 814a are down-sampled in block D 856a by 4 to 192×256 pixels and passed through another residual block 851b to produce 128 channels of this size (192×256) preserving medium-scale feature map 814b. In the next layers, the 128 channels of medium-scale features map 814b are down-sampled in another block D 856b by 4 to 96×128 pixels and passed through another residual block 851c to produce 256 channels of this size (96×128) coarse scale feature map 814c. The output is then twice successively up-sampled by 4 in up-sample blocks U 857a and 857b, and concatenated with feature models of the same size in C blocks 858a and 858b and passed through corresponding residual blocks 851d and 851e to produce, after the second up-sampling, 64 feature models 814e of full scale 384×512 pixels. These features are then combined in two different 1×1 convolutional blocks 852a and 852b to produce a two-channel cell body mask 814g and a two-channel touching cell edge mask 844f at 384×512 resolution, respectively.

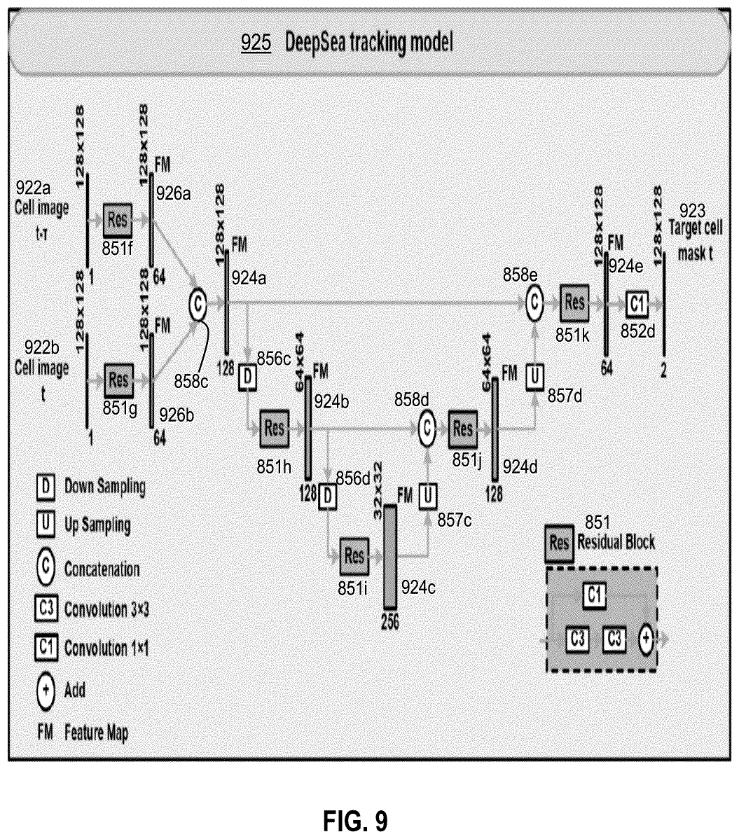

FIG. 9 is a block diagram that illustrates an example of neural network structure 925 for tracking cells in a pair of sequential, labelled, segmented microscopic video frames, according to an embodiment. In the illustrated embodiment, a portion that is 128 rows by 128 columns of pixels of each frame is input. This is advantageous for reducing the permutations of the linking problem.

The search space was limited in x and y coordinates to a small square with the size of 5 times the target cell size centered at the previous frame target cell's centroids. Then each search crop was fed into the DeepSea segmentation model 925 to only have the segmented bodies of the target single cell on the previous frame (t−1) 922a and the segmented cells on the current frame (t) 922b. The tracking model 925 predicts the target single-cell location among the segmented cells on the current frame by generating a binary mask. Each frame 922a or 922b is passed through a corresponding residual block 851f or 851g to produce a corresponding 64 channels feature map (FM) 926a or 926b of the same size. These are concatenated in block C 858c to form a 128 channel feature map 924a of the same size for fine scale features.

In the next layers, the 128 channels of fine-scale feature map 924a are down-sampled in block D 858c by 4 to 64×64 pixels and passed through another residual block 851h to produce 128 channels of this size (64×64) preserving medium-scale feature map 924b. In the next layers, the 128 channels of medium-scale feature map 924b are down-sampled in another block D 856d by 4 to 32×32 pixels and passed through another residual block 851i to produce 256 channels of this size (32×32) coarse scale feature map 924c. The output is then twice successively up-sampled by 4 in up-sample blocks U 857 c and 857d, respectively, and concatenated in blockes 858d and 858e, respectively, with feature models 924b and 924a, respectively, of the same size and passed through another residual block 851j and 851k, respectively, to produce, after the second up-sampling, 64 channel feature map 924e of full scale 128×128 pixels. This is passed through a 1×1 convolution layer C1 852d to output a 2 channel 128×128 target cell mask 923 for frame t. The mask contains at each pixel a value of a label for a cell from the previous frame (t−1) to which the pixel corresponds.

The number of the DeepSea tracking model 925 parameters is only 2.1 million, while the other deep tracking models, such as ROLO, DeepSort, and TrackRCNN, which are mostly used in other object tracking applications, involve more than 20 million parameters, confirming that we have an efficient model in the tracking process as well. Also, since the number of cell division events is naturally much fewer than single-cell tracking events, we artificially repeated and increased the cell division events fifty times more than single-cell tracking events in our training set. This helped the model see a balanced number of both single-cell links and cell divisions during the training process and thus reduced the risk of overfitting the most repeated category. The train optimization function and hyper-parameters are the same as the segmentation model training process.

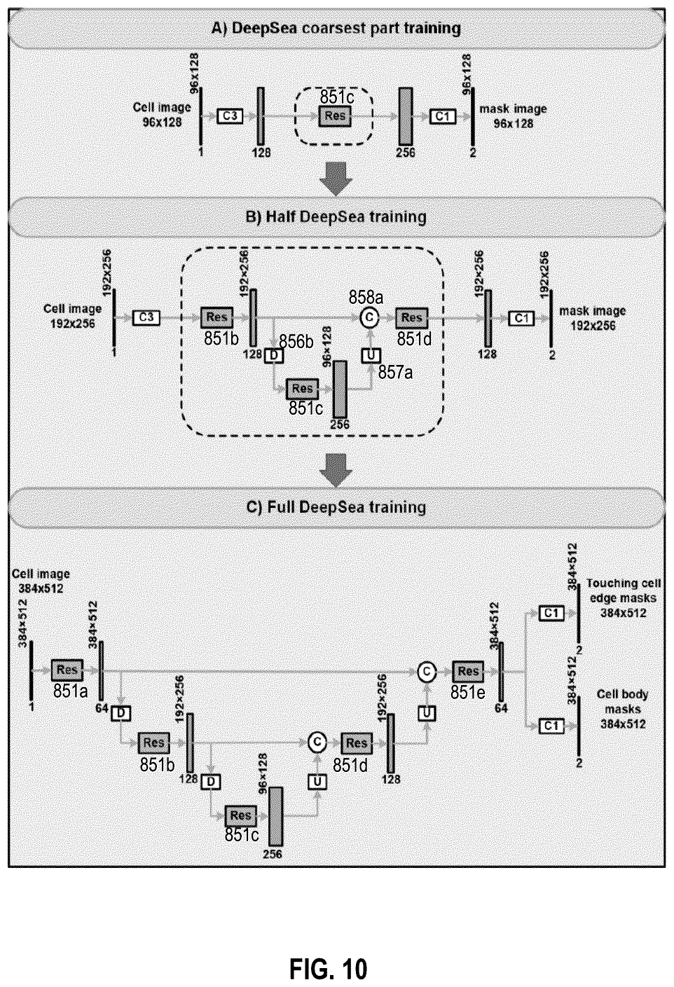

FIG. 10 is a block diagram that illustrates an example of progressive training of a neural network structures used for cell dynamics, according to an embodiment. DeepSea progressive training stages first starts training the coarsest part Residual block 851c on low-resolution ground truth images of 96×128. After some training epochs, it transfers the Res block 851c weights to the half resolution images and keeps training it and residual blocks 851b and 851d and D block 856b, U block 857a and C block 858a with the ground truth images of 192×256. Finally, it finishes the last n training epochs with the full DeepSea model training 384×512 and the blocks of FIG. 8. A similar progressive training is used at the smaller image portion used to train the tracking neural network 925. Also, when adding the higher resolution part to the training process, our learning algorithm reduces the learning rate of previously trained parts, making the different parts of the model learn information from different resolutions independently.

### 3.3 DeapSea Neural Networks Performance

The predictions were validated using the Intersection over Union (IoU) score. The IoU index, a value between 0 and 1 is also known as the Jaccard index as well, and is given by (Equation 3),

$$IoU = \frac{\begin{matrix}Area of overlap between predicted \\ pixels and ground truth pixels\end{matrix}}{\begin{matrix}Area of union encompassed by both \\ predicted pixels and ground truth pixels\end{matrix}} \qquad ( 3 )$$

The IoU score was used as a validation score to match the tracking model binary mask to each segmented cell body on the current frame and then find the true link (target cell at t−1 to selected cell at t) corresponding to the highest IoU value. A valid IoU value should be higher than a pre-defined threshold value, e.g., IoU threshold=0.5. If the model finds two or more valid IoU values, it takes it as a mitosis occurrence and thus creates the mother-daughter links between the target cell of the previous frame and the two selected cells with the highest IoU values.

In each test image, we labeled each detected cell body whose IoU index was higher than a pre-defined threshold value as a valid match and so True Positive (TP) prediction. Also, the ground truth cell body masks with no valid match were categorized into the False Negative (FN) set, and the predictions with no valid ground truth masks were labeled as the False Positive (FP) cases (non-cell objects). Then using Equation 4, we calculated the average precision (AP) value for each image in the test set, used by the other state-of-the-art methods in cell body segmentation tasks.

$$A P = \frac{T P}{T P + F N + F P} \qquad ( 4 )$$

To evaluate our tracking model in a continuous cell trajectory tracking process during an entire cell life cycle from birth to division, we used MOTA (Multiple Object Tracking Accuracy, Equation 5), which is widely used in multi-object tracking challenges.

To our knowledge, this is the first time that this metric has been used to evaluate a cell tracking model performance. We also used other commonly used tracking metrics, as follows, to give more detailed evaluation information: IDS: Identity Switch is the number of times a cell is assigned a new label in its track; MT: Mostly Tracked is the number of target cells assigned the same label for at least 80% of the video frames; ML: Mostly Lost is the number of target cells assigned the same label for at most 20% of the video frames; Frag: Fragmentation is the number of times a cell is lost in a frame but then redetected in a future frame (fragmenting the track); and, where n is the frame number, Equation 5 is expressed this way

$$M O T A = 1 - \frac{{\sum }_{n} ( F {P}_{n} + F {N}_{n} + I D S )}{{\sum }_{n} ( NUMBER OF CELLS )} \qquad ( 5 )$$

A perfect tracking model achieves MOTA=1.

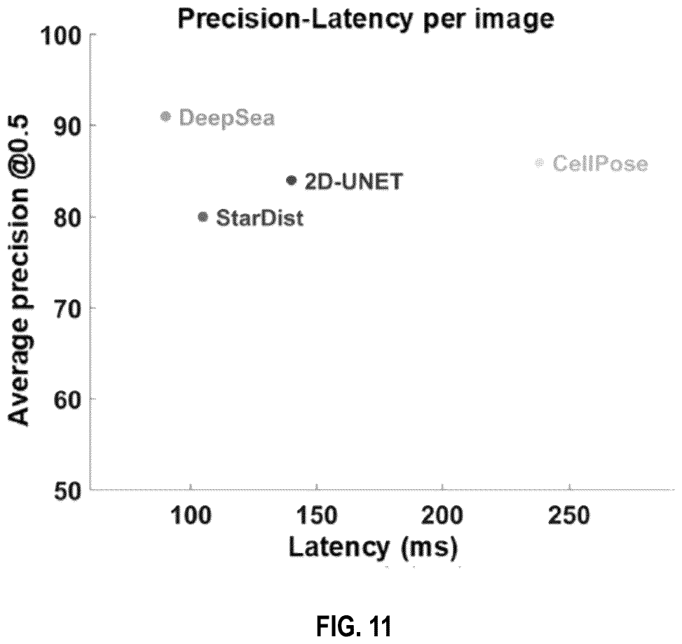

FIG. 11 is a plot that illustrates an example of superior performance in both latency and precision by the cell dynamics system, according to an embodiment. Segmentation model evaluation on the test set images by measuring models' latency (per image) shows the DeepSea embodiment has higher efficiency and lower latency than the other models available. Together, these results indicate that DeepSea's segmentation model works robustly across different densities of cells and different cell types in our dataset with high precision

FIG. 12 and FIG. 13 are tables that illustrate examples of superior performance by the cell dynamics system, according ot an embodiment. FIG. 12 shows that the example embodiment using a scaled down 2D UNet, with residual blocks and progressive learning and the edge detection attention of Equation 1 and its loss function of Equation 2 demonstrates performance that is superior to (more precise than) other neural network architecture and training using fewer of these innovations.

FIG. 13 shows single-cell tracking and mitosis detection precision compared systematically with some existing cell tracking tools. As shown, some of these tools only support a part of the required process, either single-cell tracking or mitosis detection, and some of them are proposed to be used for both, like Trackmate. Similar to the DeepSea tracking pipeline, they all first need to detect and segment the cell bodies before starting the cell tracking process and frame-by-frame cell linking. The segmentation precision of all of them with our cell images is lower than 50%. Thus, we decided to use DeepSea segmentation outputs as the input for these tracking tools to obtain the best possible tracking results and compared only cell tracking performance of these tools. We assessed the tracking model of DeepSea and other tracking tools in a full cell cycle-tracking task. The illustrated embodiment, DeepSea, performs the best, with 98% efficiency in single cell tracking and 89% efficiency in mitosis detection.

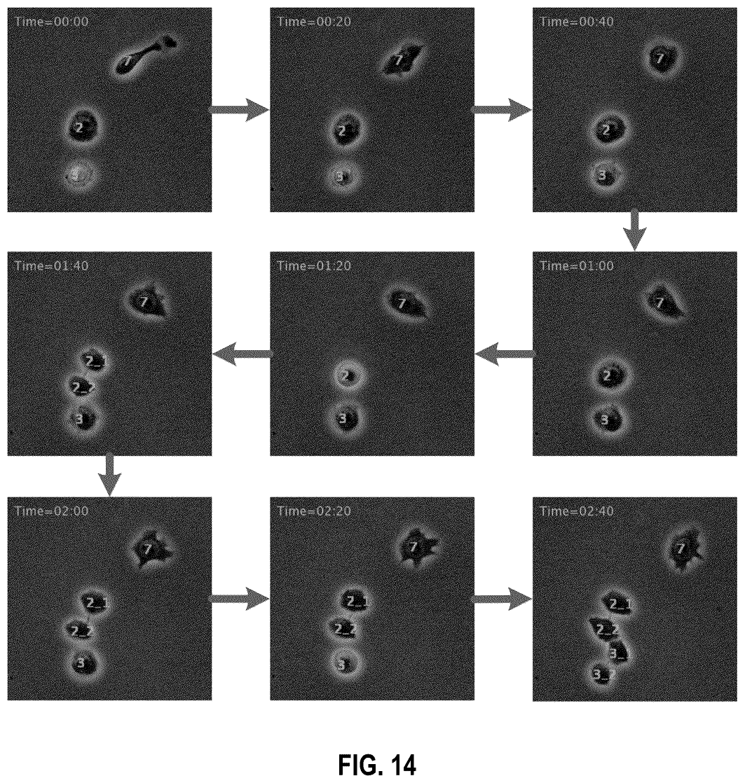

FIG. 14 is a series of image frames that illustrate an example of successful tracking of cell mitosis by the cell dynamics system, according to an embodiment. This shows one example of DeepSea's full cell cycle tracking and mitosis detection. This test uses the trained tracking model to track and label the target single-cell motion trajectories across the live-cell microscopy frame sequences from birth to division. It is obtained by feeding nine consecutive stem cell frames (with a sampling time of 20 min) to our trained tracking model. Daughter cells are linked to their mother cells by an underline (in the sixth and seventh frames).

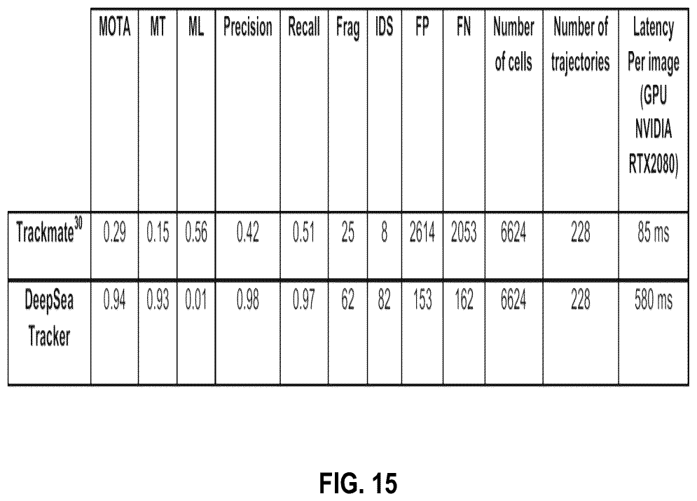

FIG. 15 is a table that illustrates an examples of superior precision by the cell dynamics system, according to an embodiment. In the evaluation process, we used 228 full ground-truth cell cycle trajectories, each including more than three consecutive frames. The Trackmate algorithm is one of the widely used cell tracking tools. The main factor for Trackmate's overall low MOTA was that it frequently did not detect mitotic events leading to high false positive (FP) and false negative (FN) labels. We also would like to note that rule-based tools like Trackmate are not trainable to be rapidly adapted to any specialized dataset.

### 3.4 Segmenting and Tracking Training GUIs

In various embodiments, graphical user interfaces (GUIs) are designed that allow human interaction to segment cells and cell nuclei in a frame and to label segmented images and to link labels on successive segmented images for producing a set of training instances that can be further augmented to build training sets for a cell dynamics measuring system. Such GUIs are presented on a display device 1614, according to embodiments using MATLAB™ (by MATHWORKS™ of Natick Massachusetts) and WINDOWS™ (by MICROSOFT™ of Redmond Washington) graphical user interfaces, respectively. The screen includes one or more active areas that allow a user to input data to operate on data. As is well known, an active area is a portion of a display to which a user can point using a pointing device (such as a cursor and cursor movement device, or a touch screen) to cause an action to be initiated by the device that includes the display. Well known forms of active areas are stand alone buttons, radio buttons, check lists, pull down menus, scrolling lists, and text boxes, among others.

### 4. Computational Hardware Overview

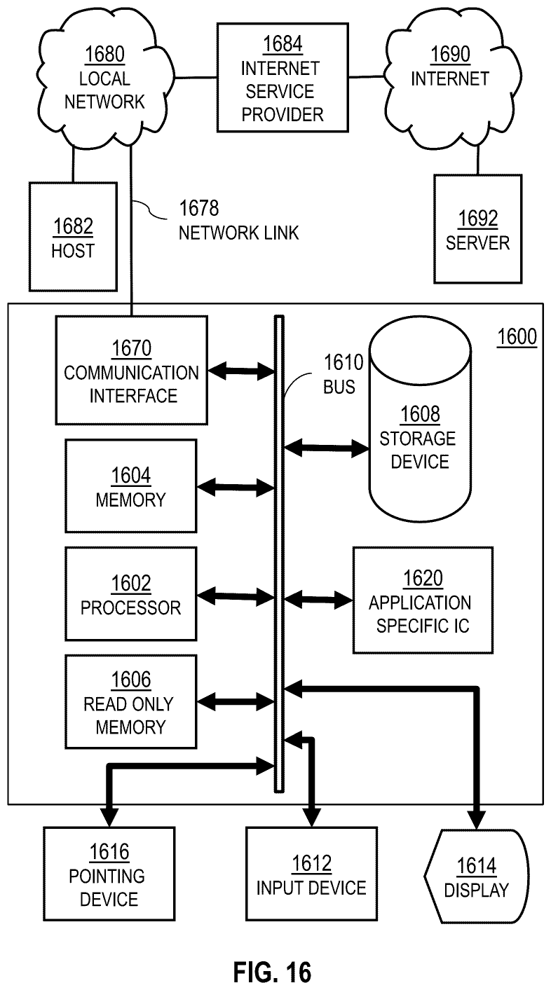

FIG. 16 is a block diagram that illustrates a computer system 1600 upon which an embodiment of the invention may be implemented. Computer system 1600 includes a communication mechanism such as a bus 1610 for passing information between other internal and external components of computer system 1600. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1600, or a portion thereof, constitutes a means for performing one or more steps of one or more methods described herein.

A sequence of binary digits constitutes digital data that is used to represent a number or code for a character. A bus 1610 includes many parallel conductors of information so that information is transferred quickly among devices coupled to the bus 1610. One or more processors 1602 for processing information are coupled with the bus 1610. A processor 1602 performs a set of operations on information. The set of operations includes bringing information in from bus 1610 and placing information on the bus 1610. The set of operations also typically includes comparing two or more units of information, shifting positions of units of information, and combining two or more units of information, such as by addition or multiplication. A sequence of operations to be executed by the processor 1602 constitutes computer instructions.

Computer system 1600 also includes a memory 1604 coupled to bus 1610. The memory 1604, such as a random access memory (RAM) or other dynamic storage device, stores information including computer instructions. Dynamic memory allows information stored therein to be changed by the computer system 1600. RAM allows a unit of information stored at a location called a memory address to be stored and retrieved independently of information at neighboring addresses. The memory 1604 is also used by processor 1602 to store temporary values during the execution of computer instructions. The computer system 1600 also includes a read only memory (ROM) 1606 or other static storage device coupled to the bus 1610 for storing static information, including instructions, that is not changed by the computer system 1600. Also coupled to bus 1610 is a non-volatile (persistent) storage device 1608, such as a magnetic disk or optical disk, for storing information, including instructions, that persists even when the computer system 1600 is turned off or otherwise loses power.

Information, including instructions, is provided to the bus 1610 for use by the processor from an external input device 1612, such as a keyboard containing alphanumeric keys operated by a human user, or a sensor. A sensor detects conditions in its vicinity and transforms those detections into signals compatible with the signals used to represent information in computer system 1600. Other external devices coupled to bus 1610, used primarily for interacting with humans, including a display device 1614, such as a cathode ray tube (CRT) or a liquid crystal display (LCD), for presenting images, and a pointing device 1616, such as a mouse or a trackball or cursor direction keys, for controlling a position of a small cursor image presented on the display 1614 and issuing commands associated with graphical elements presented on the display 1614.

In the illustrated embodiment, special purpose hardware, such as an application specific integrated circuit (IC) 1620, is coupled to bus 1610. The special purpose hardware is configured to perform operations not performed by processor 1602 quickly enough for special purposes. Examples of application specific ICs include graphics accelerator cards for generating images for display 1614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1600 also includes one or more instances of a communications interface 1670 coupled to bus 1610. Communication interface 1670 provides a two-way communication coupling to a variety of external devices that operate with their own processors, such as printers, scanners and external disks. In general the coupling is with a network link 1678 that is connected to a local network 1680 to which a variety of external devices with their own processors are connected. For example, communication interface 1670 may be a parallel port or a serial port or a universal serial bus (USB) port on a personal computer. In some embodiments, communications interface 1670 is an integrated services digital network (ISDN) card or a digital subscriber line (DSL) card or a telephone modem that provides an information communication connection to a corresponding type of telephone line. In some embodiments, a communication interface 1670 is a cable modem that converts signals on bus 1610 into signals for a communication connection over a coaxial cable or into optical signals for a communication connection over a fiber optic cable. As another example, communications interface 1670 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1670 sends and receives electrical, acoustic or electromagnetic signals, including infrared and optical signals, that carry information streams, such as digital data.

The term computer-readable medium is used herein to refer to any medium that participates in providing information to processor 1602, including instructions for execution. Such a medium may take many forms, including, but not limited to, non-volatile media, volatile media and transmission media. Non-volatile media include, for example, optical or magnetic disks, such as storage device 1608. Volatile media include, for example, dynamic memory 1604. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1602, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1602, except for carrier waves and other signals.

Logic encoded in one or more tangible media includes one or both of processor instructions on a computer-readable storage media and special purpose hardware, such as ASIC 1620.

Network link 1678 typically provides information communication through one or more networks to other devices that use or process the information. For example, network link 1678 may provide a connection through local network 1680 to a host computer 1682 or to equipment 1684 operated by an Internet Service Provider (ISP). ISP equipment 1684 in turn provides data communication services through the public, world-wide packet-switching communication network of networks now commonly referred to as the Internet 1690. A computer called a server 1692 connected to the Internet provides a service in response to information received over the Internet. For example, server 1692 provides information representing video data for presentation at display 1614.

The invention is related to the use of computer system 1600 for implementing the techniques described herein. According to one embodiment of the invention, those techniques are performed by computer system 1600 in response to processor 1602 executing one or more sequences of one or more instructions contained in memory 1604. Such instructions, also called software and program code, may be read into memory 1604 from another computer-readable medium such as storage device 1608. Execution of the sequences of instructions contained in memory 1604 causes processor 1602 to perform the method steps described herein. In alternative embodiments, hardware, such as application specific integrated circuit 1620, may be used in place of or in combination with software to implement the invention. Thus, embodiments of the invention are not limited to any specific combination of hardware and software.

The signals transmitted over network link 1678 and other networks through communications interface 1670, carry information to and from computer system 1600. Computer system 1600 can send and receive information, including program code, through the networks 1680, 1690 among others, through network link 1678 and communications interface 1670. In an example using the Internet 1690, a server 1692 transmits program code for a particular application, requested by a message sent from computer 1600, through Internet 1690, ISP equipment 1684, local network 1680 and communications interface 1670. The received code may be executed by processor 1602 as it is received, or may be stored in storage device 1608 or other non-volatile storage for later execution, or both. In this manner, computer system 1600 may obtain application program code in the form of a signal on a carrier wave.

Various forms of computer readable media may be involved in carrying one or more sequence of instructions or data or both to processor 1602 for execution. For example, instructions and data may initially be carried on a magnetic disk of a remote computer such as host 1682. The remote computer loads the instructions and data into its dynamic memory and sends the instructions and data over a telephone line using a modem. A modem local to the computer system 1600 receives the instructions and data on a telephone line and uses an infra-red transmitter to convert the instructions and data to a signal on an infra-red a carrier wave serving as the network link 1678. An infrared detector serving as communications interface 1670 receives the instructions and data carried in the infrared signal and places information representing the instructions and data onto bus 1610. Bus 1610 carries the information to memory 1604 from which processor 1602 retrieves and executes the instructions using some of the data sent with the instructions. The instructions and data received in memory 1604 may optionally be stored on storage device 1608, either before or after execution by the processor 1602.

### 5. Alternatives, Deviations and Modifications

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

### 6. References

These references are hereby incorporated by reference as if fully set forth herein except for terminology inconsistent with that used herein.
1. Fiorentino, J., Torres-Padilla, M.-E., and Scialdone, A. (2020). Measuring and modeling single-cell heterogeneity and fate decision in mouse embryos. Annu. Rev. Genet. 54, 167-187.
2. Bogdan, P., Deasy, B. M., Gharaibeh, B., Roehrs, T., and Marculescu, R. (2014). Heterogeneous structure of stem cells dynamics: statistical models and quantitative predictions. Sci. Rep. 4, 4826.
3. Semrau, S., Goldmann, J. E., Soumillon, M., Mikkelsen, T. S., Jaenisch, R., and van Oudenaarden, A. (2017). Dynamics of lineage commitment revealed by single-cell transcriptomics of differentiating embryonic stemcells. Nat. Commun. 8, 1096.
4. Skylaki, S., Hilsenbeck, O., and Schroeder, T. (2016). Challenges in longterm imaging and quantification of single-cell dynamics. Nat. Biotechnol.34, 1137-1144.
5. Chessel, A., and Carazo Salas, R. E. (2019). From observing to predicting single-cell structure and function with high-throughput/high-content microscopy. Essays Biochem. 63, 197-208.
6. Zatulovskiy, E., Zhang, S., Berenson, D. F., Topacio, B. R., and Skotheim, J. M. (2020). Cell growth dilutes the cell cycle inhibitor Rb to trigger cell division. Science 369, 466-471. https://doi.org/10.1126/science.aaz6213.
7. Ciaparrone, G., Luque Sa'nchez, F., Tabik, S., Troiano, L., Tagliaferri, R., and Herrera, F.
(2020). Deep learning in video multi-object tracking: a survey. Neurocomputing 381, 61-88.
8. Yun, S., and Kim, S. (2019). Recurrent YOLO and LSTM-Based IR Single Pedestrian Tracking, pp. 94-96.
9. Zhou, X., Wang, D., and Kra″henb€uhl, P. (2019). Objects as points. Preprint at arxiv.
10. Ouyang, W., Aristov, A., Lelek, M., Hao, X., and Zimmer, C. (2018). Deep learning massively accelerates super-resolution localization microscopy. Nat. Biotechnol. 36, 460-468.
11. Wang, H., Rivenson, Y., Jin, Y., Wei, Z., Gao, R., G€unaydin, H., Bentolila, L. A., Kural, C., and Ozcan, A. (2019). Deep learning enables cross-modality super-resolution in fluorescence microscopy. Nat. Methods 16, 103-110.
12. Beier, T., Pape, C., Rahaman, N., Prange, T., Berg, S., Bock, D. D., Cardona, A., Knott, G. W., Plaza, S. M., Scheffer, L. K., et al. (2017). Multicutbrings automated neurite segmentation closer to human performance. Nat. Methods 14, 101-102.
13. Weigert, M., Schmidt, U., Boothe, T., M€uller, A., Dibrov, A., Jain, A., Wilhelm, B., Schmidt, D., Broaddus, C., Culley, S., et al. (2018). Content aware image restoration: pushing the limits of fluorescence microscopy. Nat. Methods 15, 1090-1097.
14. Wu, Y., Rivenson, Y., Wang, H., Luo, Y., Ben-David, E., Bentolila, L. A., Pritz, C., and Ozcan, A. (2019). Three-dimensional virtual refocusing of fluorescence microscopy images using deep learning. Nat. Methods 16, 1323-1331.
15. Stringer, C., Wang, T., Michaelos, M., and Pachitariu, M. (2021). Cellpose: a generalist algorithm for cellular segmentation. Nat. Methods 18, 100-106.
16. Schmidt, U., Weigert, M., Broaddus, C., and Myers, G. (2018). In Cell Detection with Star-Convex Polygons. held in Cham, 2018//. A. F. Frangi, J. A. Schnabel, C. Davatzikos, C. Alberola-Lo'pez, and G. Fichtinger, eds. (Springer International Publishing), pp. 265-273.
17. Liu, L., Ouyang, W., Wang, X., Fieguth, P., Chen, J., Liu, X., and Pietika″inen, M. (2019). Deep learning for generic object detection: a survey. Preprint at arxiv.
18. Minaee, S., Boykov, Y., Porikli, F., Plaza, A., Kehtarnavaz, N., and Terzopoulos, D. (2020). Image segmentation using deep learning: a survey. Preprint at arxiv.
19. Khan, A., Nawaz, U., Ulhaq, A., and Robinson, R. W. (2020). Real-timeplant health assessment via implementing cloud-based scalable transfer learning on AWS DeepLens. PLoS One 15, e0243243.
20. Mumuni, A., and Mumuni, F. (2022). Data augmentation: a comprehensive survey of modern approaches. Array 16, 100258.
21. Siddique, N., Paheding, S., Elkin, C. P., and Devabhaktuni, V. (2021). U-net and its variants for medical image segmentation: a review of theory and applications. IEEE Access 9, 82031-82057.
22. He, K., Zhang, X., Ren, S., and Sun, J. (2015). Deep residual learning for image recognition. Preprint at arxiv.
23. Liu, T., Chen, M., Zhou, M., Du, S. S., Zhou, E., and Zhao, T. (2019). Towards understanding the importance of shortcut connections in residual networks.
24. Shafiq, M., and Gu, Z. (2022). Deep residual learning for image recognition: a survey. Appl. Sci. 12, 8972.
25. Karras, T., Aila, T., Laine, S., and Lehtinen, J. (2018). Progressive growing of GANs for improved quality, stability, and variation. Preprint at arxiv.
26. Ronneberger, O., Fischer, P., and Brox, T. (2015). U-net: convolutional networks for biomedical image segmentation. Preprint at arxiv.
27. Piccinini, F., Kiss, A., and Horvath, P. (2016). CellTracker (not only) for dummies. Bioinformatics 32, 955-957.
28. He, T., Mao, H., Guo, J., and Yi, Z. (2017). Cell tracking using deep neural networks with multi-task learning. Image Vis Comput. 60, 142-153.
29. Nishimura, K., and Bise, R. (2020). Spatial-temporal mitosis detection in phase-contrast microscopy via likelihood map estimation by 3DCNN. Annu. Int. Conf. IEEE Eng. Med. Biol. Soc. 2020, 1811-1815.
30. Ershov, D., Phan, M.-S., Pylva″na″inen, J. W., Rigaud, S. U., Le Blanc, L., Charles-Orszag, A., Conway, J. R. W., Laine, R. F., Roy, N. H., Bonazzi, D., et al. (2022). TrackMate 7: integrating state-of-the-art segmentation algorithms into tracking pipelines. Nat. Methods 19, 829-832.
31. Bo, W., and Nevatia, R. (2006). Tracking of Multiple, Partially Occluded Humans Based on Static Body Part Detection, pp. 951-958.
32. Ristani, E., Solera, F., Zou, R., Cucchiara, R., and Tomasi, C. (2016). Performance measures and a data set for multi-target, multi-camera tracking.
33. Zatulovskiy, E., and Skotheim, J. M. (2020). On the molecular mechanisms regulating animal cell size homeostasis. Trends Genet. 36, 360-372.
34. Boward, B., Wu, T., and Dalton, S. (2016). Concise review: control of cell fate through cell cycle and pluripotency networks. Stem Cell. 34, 1427-1436.
35. Liu, L., Michowski, W., Kolodziejczyk, A., and Sicinski, P. (2019). The cell cycle in stem cell proliferation, pluripotency and differentiation. Nat. Cell Biol. 21, 1060-1067.
36. Fei, D. L., Motowski, H., Chatrikhi, R., Prasad, S., Yu, J., Gao, S., Kielkopf, C. L., Bradley,
R. K., and Varmus, H. (2016). Wild-type U2AF1 antagonizes the splicing program characteristic of U2AF1-mutant tumors and is required for cell survival. PLoS Genet. 12, e1006384.
37. Sato, M., Larsen, J. E., Lee, W., Sun, H., Shames, D. S., Dalvi, M. P., Ramirez, R. D., Tang, H., DiMaio, J. M., Gao, B., et al. (2013). Human lung epithelial cells progressed to malignancy through specific oncogenic manipulations. Mol. Cancer Res. 11, 638-650.
38. Ker, D. F. E., Eom, S., Sanami, S., Bise, R., Pascale, C., Yin, Z., Huh, S.-i., Osuna-Highley, E., Junkers, S. N., Helfrich, C. J., et al. (2018). Phase contrast time-lapse microscopy datasets with automated and manual cell tracking annotations. Sci. Data 5, 180237.
39. Thambawita, V., Streumke, I., Hicks, S. A., Halvorsen, P., Parasa, S., and Riegler, M. A. (2021). Impact of image resolution on deep learning performance in endoscopy image classification: an experimental study using a large dataset of endoscopic images. Diagnostics 11, 2183.
40. Sabottke, C. F., and Spieler, B. M. (2020). The effect of image resolution on deep learning in radiography. Radiol. Artif. Intell. 2, e190015. https://doi.org/10.1148/ryai.2019190015.
41. Zhao, H., Shi, J., Qi, X., Wang, X., and Jia, J. (2017). Pyramid scene parsing network.
42. Badrinarayanan, V., Kendall, A., and Cipolla, R. (2017). SegNet: a deep convolutional encoder-decoder architecture for image segmentation. IEEE Trans. Pattern Anal. Mach. Intell. 39, 2481-2495.
43. Ioffe, S., and Szegedy, C. (2015). Batch normalization: accelerating deep network training by reducing internal covariate shift. In Proceedings of the 32nd International Conference on International Conference on Machine Learning, 37. JMLR.org.
44. Jadon, S. (2020). A Survey of Loss Functions for Semantic Segmentation (IEEE).
45. Rezatofighi, H., Tsoi, N., Gwak, J., Sadeghian, A., Reid, I., and Savarese, S. (2019).
Generalized intersection over union: a metric and A loss for bounding box regression. Preprint at arxiv.
46. Ning, G., Zhang, Z., Huang, C., He, Z., Ren, X., and Wang, H. (2016). Spatially supervised recurrent convolutional neural networks for visual object tracking. Preprint at arxiv.
47. Wojke, N., Bewley, A., and Paulus, D. (2017). Simple online and realtime tracking with a deep association metric.
48. Voigtlaender, P., Krause, M., Osep, A., Luiten, J., Sekar, B. B., Geiger, A., and Leibe, B. (2019). MOTS: multi-object tracking and segmentation.

What is claimed is:

1. A non-transitory computer-readable medium carrying one or more sequences of instructions for measuring cell dynamics, wherein execution of the one or more sequences of instructions by one or more processors causes the one or more processors to perform the steps of:
retrieving from a computer-readable medium observation data that indicates a plurality of image frames of a microscopic video suitable for detecting a biological cell;
generating boundary data that indicates a boundary of each cell in at least two image frames of the observation data based on the observation data and a segmenting neural network trained with segmenting training data that indicates cell boundaries for each of one or more frame images different from any frame images in the observation data;
generating tracking data that indicates a linkage between a boundary of a first cell in a first image frame of the at least two image frames and a boundary of the first cell in a second image frame of the at least two image frames based on the boundary data and a tracking neural network trained with tracking training data that indicates linkages between a boundary of each cell in a first image frame and a boundary of a corresponding cell in a second image frame for each boundary in the segmenting training data;
generating cell dynamics data for the first cell based on the boundary of the first cell in the first image frame and the boundary of the first cell in the second image frame; and
sending a signal that indicates the cell dynamics data for the first cell.

2. The non-transitory computer-readable medium as recited in claim 1, wherein the segmenting training data includes one or more augmented frame images derived from a non-augmented frame image by randomly varying the location or size of one or more cells and the corresponding boundaries or by randomly changing one or more image properties such as intensity, contrast, noise, or clutter, or some combination.

3. The non-transitory computer-readable medium as recited in claim 1, wherein the segmenting training data includes a number of frames with edge-touching cells that is a same order of magnitude as a number of frames without edge touching cells.

4. The non-transitory computer-readable medium as recited in claim 1, wherein the segmenting neural network includes a residual convolutional layer.

5. The non-transitory computer-readable medium as recited in claim 1, wherein the segmenting neural network includes an edge detection layer configured to give more weight to nodes representing image pixels near a boundary of a cell.

6. The non-transitory computer-readable medium as recited in claim 1, wherein the segmenting neural network is progressively trained on increasingly higher resolution imagery.

7. The non-transitory computer-readable medium as recited in claim 1, wherein the tracking training data includes one or more augmented linkages derived from a non-augmented linkages by randomly varying the shape of one or more boundaries.

8. The non-transitory computer-readable medium as recited in claim 1, wherein the tracking training data includes a number of cell division linkages that is a same order of magnitude as a number of linkages without cell division.

9. The non-transitory computer-readable medium as recited in claim 1, wherein the tracking neural network includes a residual convolutional layer.

10. The non-transitory computer-readable medium as recited in claim 1, wherein the tracking neural network is progressively trained on increasingly higher resolution imagery.

11. The non-transitory computer-readable medium as recited in claim 1, wherein said cell dynamics data for the first cell includes cell size or nucleus size or growth rate or mitosis or cell life cycle or changes thereof for the first cell.

12. An apparatus for measuring cell dynamics, the apparatus comprising:
at least one processor; and
at least one memory including one or more sequences of instructions,
the at least one memory and the one or more sequences of instructions configured to, with the at least one processor, cause the apparatus to perform at least the following,
retrieving from a computer-readable medium observation data that indicates a plurality of image frames of a microscopic video suitable for detecting a biological cell;
generating boundary data that indicates a boundary of each cell in at least two image frames of the observation data based on the observation data and a segmenting neural network trained with segmenting training data that indicates cell boundaries for each of one or more frame images different from any frame images in the observation data;
generating tracking data that indicates a linkage between a boundary of a first cell in a first image frame of the at least two image frames and a boundary of the first cell in a second image frame of the at least two image frames based on the boundary data and a tracking neural network trained with tracking training data that indicates linkages between a boundary of each cell in a first image frame and a boundary of a corresponding cell in a second image frame for each boundary in the segmenting training data;
generating cell dynamics data for the first cell based on the boundary of the first cell in the first image frame and the boundary of the first cell in the second image frame; and
sending a signal that indicates the cell dynamics data for the first cell.

13. A system for measuring cell dynamics, the apparatus comprising:
the apparatus of claim 12; and
a microscopic video device configured to obtain and record the observation data.

14. A method executed on a processor for measuring cell dynamics, the method comprising:
retrieving from a computer-readable medium observation data that indicates a plurality of image frames of a microscopic video suitable for detecting a biological cell;
generating boundary data that indicates a boundary of each cell in at least two image frames of the observation data based on the observation data and a segmenting neural network trained with segmenting training data that indicates cell boundaries for each of one or more frame images different from any frame images in the observation data;
generating tracking data that indicates a linkage between a boundary of a first cell in a first image frame of the at least two image frames and a boundary of the first cell in a second image frame of the at least two image frames based on the boundary data and a tracking neural network trained with tracking training data that indicates linkages between a boundary of each cell in a first image frame and a boundary of a corresponding cell in a second image frame for each boundary in the segmenting training data;
generating cell dynamics data for the first cell based on the boundary of the first cell in the first image frame and the boundary of the first cell in the second image frame; and
sending a signal that indicates the cell dynamics data for the first cell.

15. A method executed on a processor for measuring cell dynamics, the method comprising:
training a segmenting neural network with segmenting training data that indicates cell boundaries for each of one or more frame images;
training a tracking neural network with tracking training data that indicates linkages between a boundary of each cell in a first image frame and a boundary of a corresponding cell in a second image frame for each boundary in the segmenting training data;
retrieving from a computer-readable medium observation data that indicates a plurality of image frames of a microscopic video suitable for detecting a biological cell, wherein the observation data is different from the segmenting training data;
generating boundary data that indicates a boundary of each cell in at least two image frames of the observation data based on the observation data and the segmenting neural network;
generating tracking data that indicates a linkage between a boundary of a first cell in a first image frame of the at least two image frames and a boundary of the first cell in a second image frame of the at least two image frames based on the boundary data and the tracking neural network;
generating cell dynamics data for the first cell based on the boundary of the first cell in the first image frame and the boundary of the first cell in the second image frame; and
sending a signal that indicates the cell dynamics data for the first cell.

16. A non-transitory computer-readable medium carrying one or more sequences of instructions for measuring cell dynamics, wherein execution of the one or more sequences of instructions by one or more processors causes the one or more processors to perform at least:
training a segmenting neural network with segmenting training data that indicates cell boundaries for each of one or more frame images;
training a tracking neural network with tracking training data that indicates linkages between a boundary of each cell in a first image frame and a boundary of a corresponding cell in a second image frame for each boundary in the segmenting training data;
retrieving from a computer-readable medium observation data that indicates a plurality of image frames of a microscopic video suitable for detecting a biological cell, wherein the observation data is different from the segmenting training data;
generating boundary data that indicates a boundary of each cell in at least two image frames of the observation data based on the observation data and the segmenting neural network;
generating tracking data that indicates a linkage between a boundary of a first cell in a first image frame of the at least two image frames and a boundary of the first cell in a second image frame of the at least two image frames based on the boundary data and the tracking neural network;
generating cell dynamics data for the first cell based on the boundary of the first cell in the first image frame and the boundary of the first cell in the second image frame; and
sending a signal that indicates the cell dynamics data for the first cell.

17. An apparatus for measuring cell dynamics, the apparatus comprising:
at least one processor; and
at least one memory including one or more sequences of instructions,
the at least one memory and the one or more sequences of instructions configured to, with the at least one processor, cause the apparatus to perform at least:
training a segmenting neural network with segmenting training data that indicates cell boundaries for each of one or more frame images;
training a tracking neural network with tracking training data that indicates linkages between a boundary of each cell in a first image frame and a boundary of a corresponding cell in a second image frame for each boundary in the segmenting training data;
retrieving from a computer-readable medium observation data that indicates a plurality of image frames of a microscopic video suitable for detecting a biological cell, wherein the observation data is different from the segmenting training data;
generating boundary data that indicates a boundary of each cell in at least two image frames of the observation data based on the observation data and the segmenting neural network;
generating tracking data that indicates a linkage between a boundary of a first cell in a first image frame of the at least two image frames and a boundary of the first cell in a second image frame of the at least two image frames based on the boundary data and the tracking neural network;
generating cell dynamics data for the first cell based on the boundary of the first cell in the first image frame and the boundary of the first cell in the second image frame; and
sending a signal that indicates the cell dynamics data for the first cell.

18. A system for measuring cell dynamics, the apparatus comprising:
the apparatus of claim 17; and
a microscopic video device configured to obtain and record the observation data.
